(19) United States
(12) Patent Application Publication
(10) Pub. No.: US 2023/0156024 A1
(43) Pub. Date: May 18, 2023

(54) SYSTEM AND METHOD FOR FRAUD IDENTIFICATION UTILIZING COMBINED METRICS

(71) Applicant: Verizon Media Inc., New York, NY (US)

(72) Inventors: Timothy Michael Olson, Mahomet, IL (US); Shaima Abdul Majeed, Champaign, IL (US); Emily Bernotas, Urbana, IL (US); Susan Phillips Kimura, Beverly Hills, CA (US); Rajat Mittal, Champaign, IL (US)

(21) Appl. No.: 17/529,486

(22) Filed: Nov. 18, 2021

(51) Int. Cl. H04L 29/06; G06Q 30/02

(52) U.S. Cl. CPC H04L 63/1425; G06Q 30/0248

(57) ABSTRACT

One or more computing devices, systems, and/or methods are provided. First event information associated with a plurality of events may be determined, wherein the plurality of events is associated with a first entity. A set of event metrics associated with the first entity may be determined based upon the first event information. A first combined metric may be determined based upon at least two metrics of the set of event metrics. Whether the first entity is fraudulent may be determined based upon the first combined metric and a threshold metric associated with anomalous behavior.

### BACKGROUND

Many applications, such as websites, applications, etc. may provide platforms for viewing media. For example, a request for media may be received from a device associated with a user. Responsive to receiving the request for media, media may be transmitted to the device. However, the request for media may be fraudulent.

### SUMMARY

In accordance with the present disclosure, one or more computing devices and/or methods are provided. In an example, first event information, associated with a plurality of events within a period of time, may be determined. The plurality of events is associated with a plurality of entities. A plurality of sets of event metrics associated with the plurality of entities may be determined based upon the first event information. A first set of event metrics of the plurality of sets of event metrics is associated with a first entity of the plurality of entities. A second set of event metrics of the plurality of sets of event metrics is associated with a second entity of the plurality of entities. A first plurality of combined metrics may be determined based upon the plurality of sets of event metrics. Determining the first plurality of combined metrics comprises determining a first combined metric of the first plurality of combined metrics based upon at least two event metrics of the first set of event metrics associated with the first entity. Determining the first plurality of combined metrics comprises determining a second combined metric of the first plurality of combined metrics based upon at least two event metrics of the second set of event metrics associated with the second entity. A threshold metric associated with anomalous behavior may be determined based upon the first plurality of combined metrics. It may be determined that one or more first entities of the plurality of entities are fraudulent based upon the threshold metric and one or more combined metrics, of the first plurality of combined metrics, associated with the one or more first entities.

In an example, first event information associated with a plurality of events within a period of time may be determined. The plurality of events is associated with a first entity. A set of event metrics associated with the first entity may be determined based upon the first event information. A first combined metric may be determined based upon at least two metrics of the set of event metrics. Whether the first entity is fraudulent may be determined based upon the first combined metric and a threshold metric associated with anomalous behavior.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4A is a flow chart illustrating an example method for identifying fraudulent entities.

FIG. 4B is a flow chart illustrating an example method for identifying fraudulent entities.

FIG. 5A is a component block diagram illustrating an example system for identifying fraudulent entities, where a first client device presents a first video via a first internet resource associated with a first entity.

FIG. 5B is a component block diagram illustrating an example system for identifying fraudulent entities, where a first client device presents a first content item.

FIG. 5C is a component block diagram illustrating an example system for identifying fraudulent entities, where a plurality of sets of event metrics associated with a plurality of entities is determined based upon first event information.

FIG. 5D is a component block diagram illustrating an example system for identifying fraudulent entities, where a first plurality of combined metrics associated with a plurality of entities is determined based upon a plurality of sets of event metrics.

FIG. 5E is a component block diagram illustrating an example system for identifying fraudulent entities, where a first threshold metric is determined.

FIG. 6 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

1. Computing Scenario

The following provides a discussion of some types of computing scenarios in which the disclosed subject matter may be utilized and/or implemented.

1.1. Networking

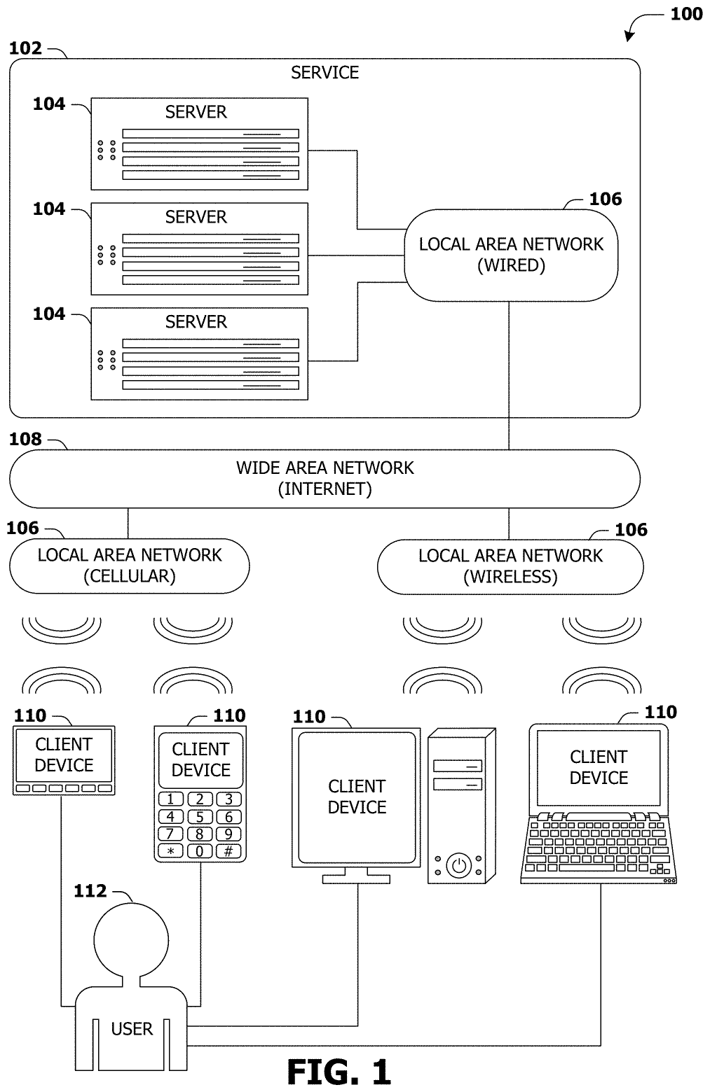

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

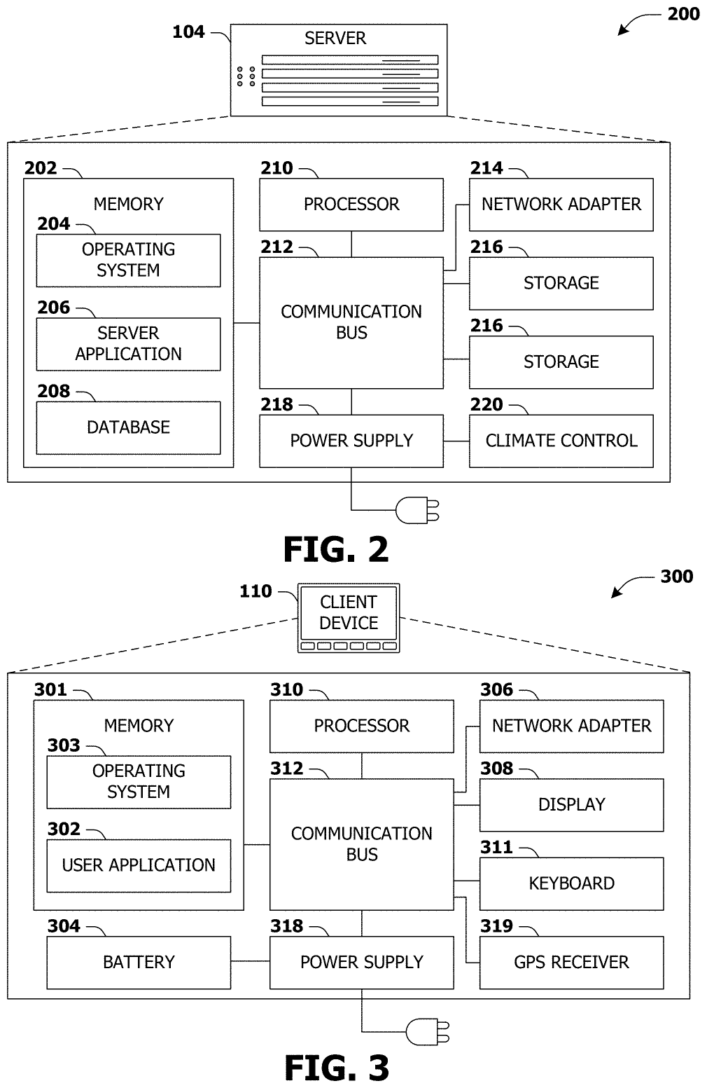

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

2. Presented Techniques

One or more computing devices and/or techniques for identifying fraudulent entities are provided. A fraudulent entity may correspond to an entity, such as one or more internet resources (e.g., websites, web pages, domains, applications, etc.), one or more supply side platforms (SSPs) (e.g., one or more ad exchanges) and/or one or more clients (e.g., client devices, IP addresses, etc.), that performs fraudulent activity. An example of such fraudulent activity may include, but is not limited to, advertising fraud. Other examples of fraudulent activity performed by fraudulent entities are data fraud, spam messaging, etc. In advertising fraud, advertisement signals associated with fraudulent entities may be received by an advertising system. The advertisement signals may indicate advertisement impressions, clicks, conversions, etc. performed by a client in association with an internet resource and/or an SSP. However, the purported advertisement impressions, clicks, conversions, etc. may not be performed by legitimate users having an interest in relevant advertisements. Rather, the advertisement signals may be transmitted to the advertising system by a system of one or more fraudulent entities employing at least one of botnets, hacked client devices (e.g., zombie computers), click farms, fake websites, data centers, etc. Administrators of fraudulent entities may request compensation for the purported advertisement impressions, clicks, conversions, etc., and, unless the fraudulent entities are identified and flagged as fraudulent, the administrators may continue being compensated. Advertising fraud is estimated to cost the advertising industry billions of dollars per year and automated and/or real-time solutions to advertising fraud are needed.

Thus, in accordance with one or more of the techniques presented herein, first event information associated with a plurality of events within a period of time may be determined. The plurality of events is associated with a first entity. In an example, the first event information may be determined by aggregating data to collect network traffic (e.g., internet traffic, such as advertisement traffic), associated with the plurality of events, on a demand side platform (DSP) of a content system. Events of the plurality of events may be performed by the first entity and/or may be performed in association with (and/or utilizing) the first entity. A set of event metrics associated with the first entity may be determined based upon the first event information. A first combined metric may be determined based upon at least two metrics of the set of event metrics. For example, the first combined metric may be at least one of a ratio of a first metric to a second metric, the first metric divided by the second metric, etc. Whether the first entity is fraudulent may be determined based upon the first combined metric and a threshold metric associated with anomalous behavior. For example, it may be determined that the first entity is fraudulent based upon a determination that the first combined metric meets the threshold metric. The threshold metric may be determined using other combined metrics associated with other entities, historical combined metric data, one or more anomaly detection techniques, one or more combined metrics associated with one or more known fraudulent entities, one or more combined metrics associated with one or more known non-fraudulent entities, and/or other information.

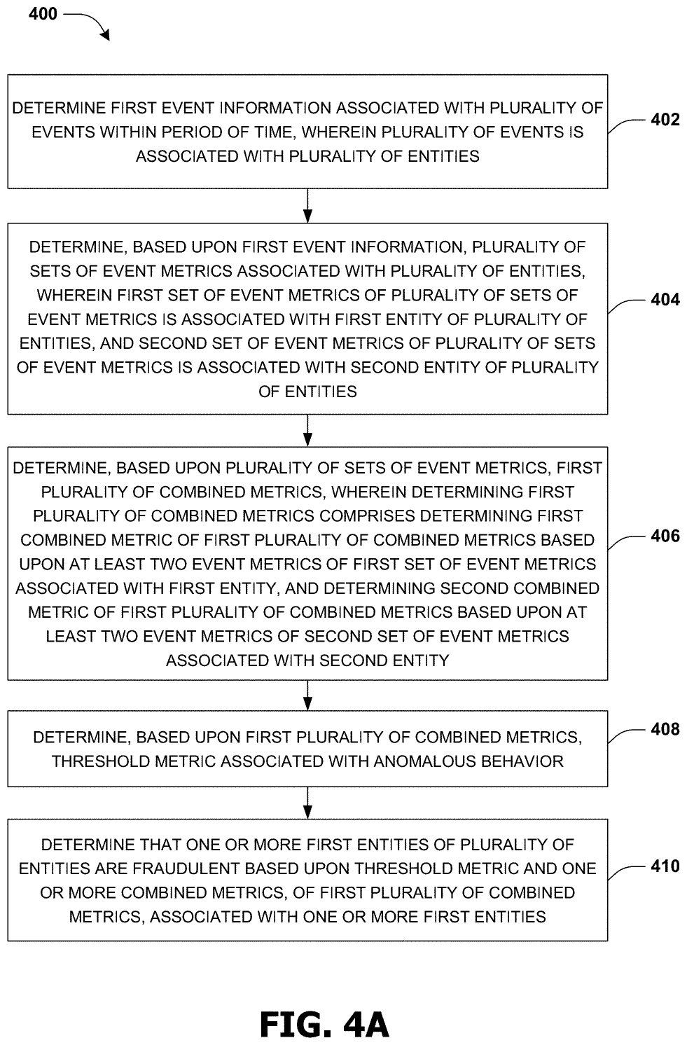

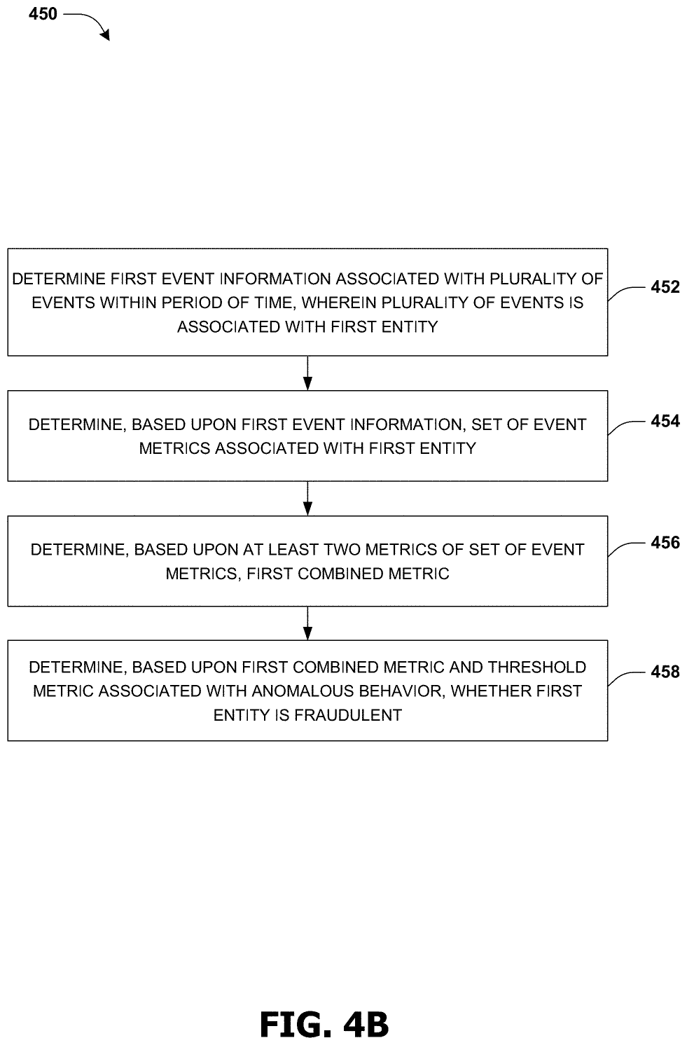

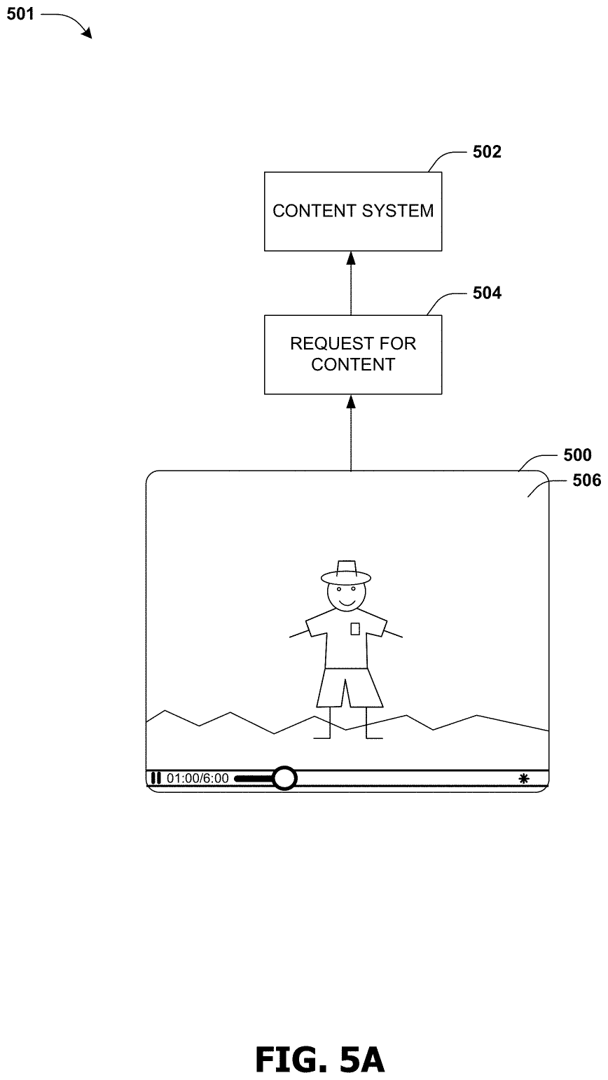

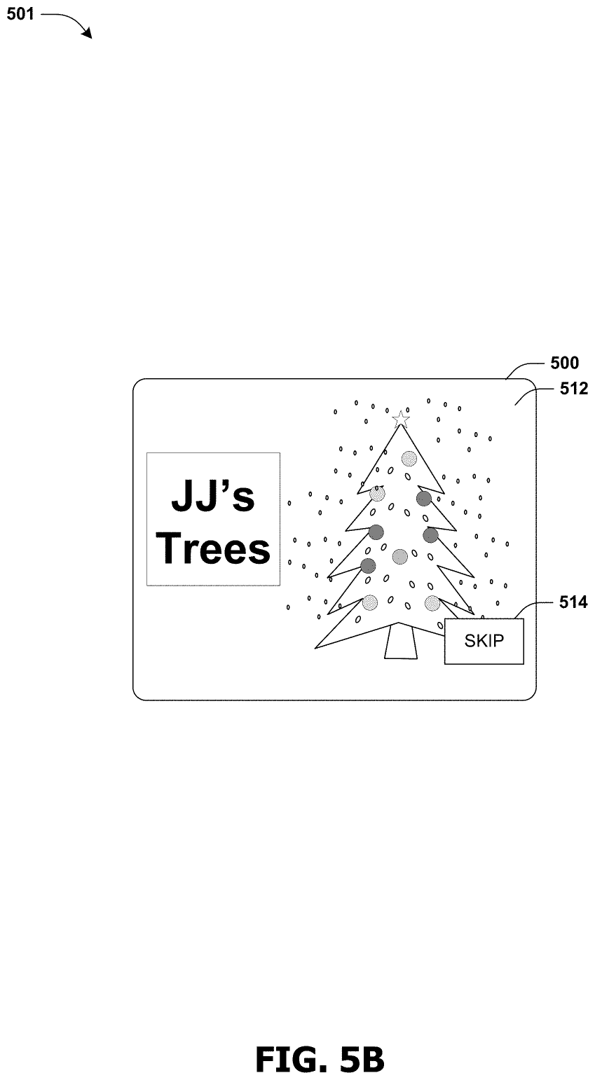

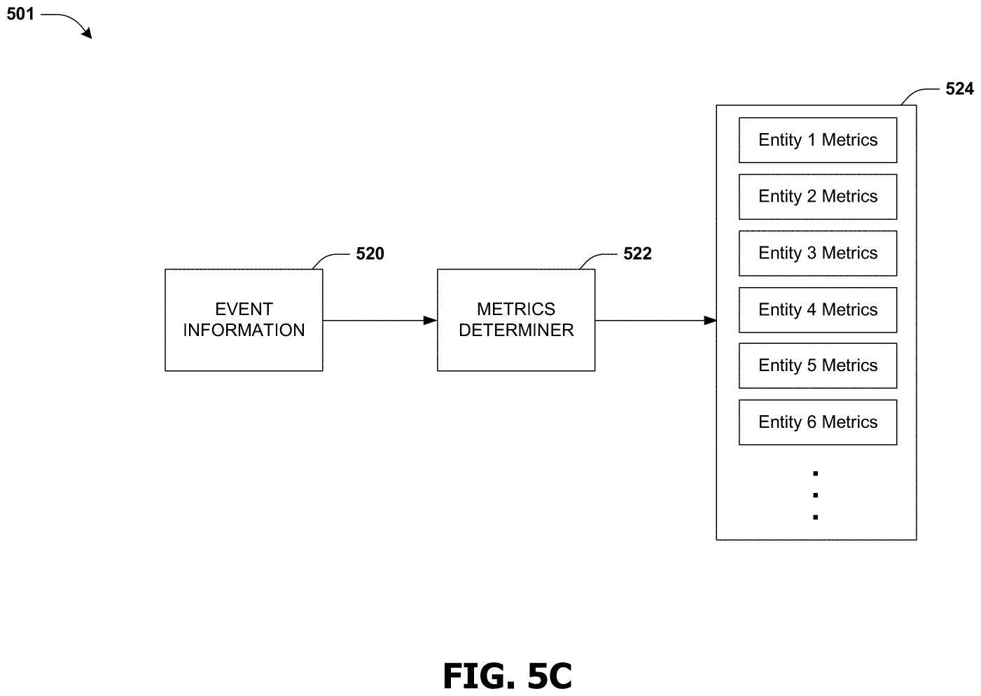

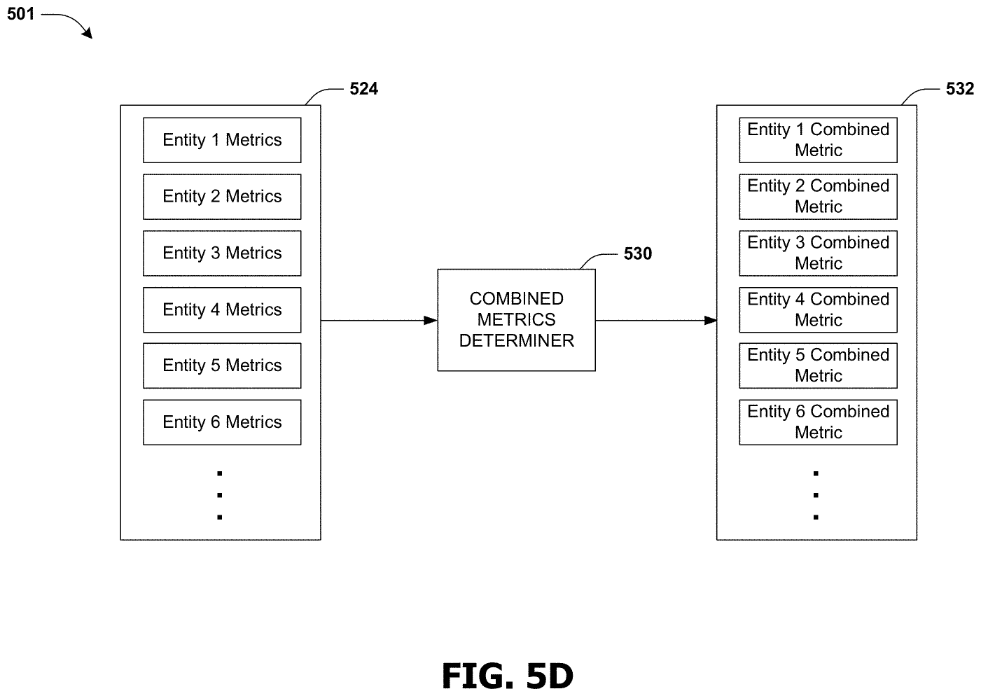

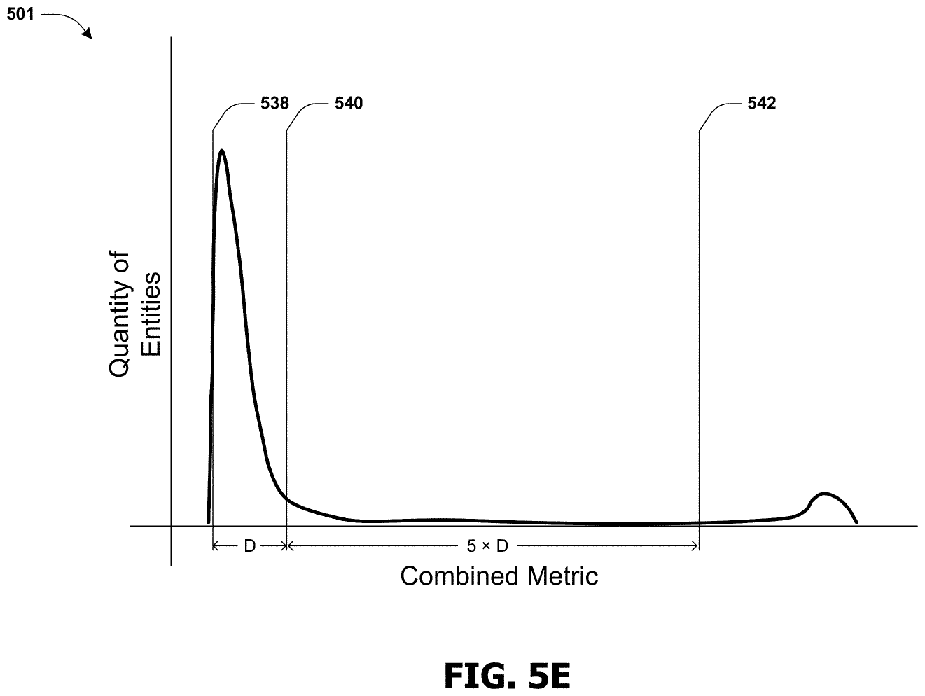

An embodiment of identifying fraudulent entities is illustrated by an example method 400 of FIG. 4A, and is further described in conjunction with system 501 of FIGS. 5A-5E. A content system for presenting content via devices may be provided. In some examples, the content system may be an advertisement system (e.g., an online advertising system). Alternatively and/or additionally, the content system may not be an advertisement system. In some examples, the content system may provide content items to be presented via pages associated with the content system. For example, the pages may be associated with websites (e.g., websites providing search engines, email services, news content, communication services, etc.) associated with the content system. The content system may provide content items to be presented in (dedicated) locations throughout the pages (e.g., one or more areas of the pages configured for presentation of content items). For example, a content item may be presented at the top of a web page associated with the content system (e.g., within a banner area), at the side of the web page (e.g., within a column), in a pop-up window, overlaying content of the web page, etc. Alternatively and/or additionally, a content item may be presented within an application associated with the content system and/or within a game associated with the content system. For example, the content system may provide content items to be presented via one or more video streaming applications (e.g., connected TV (CTV) applications). For example, the content items (e.g., advertisement videos) may be presented intermittently between playback of videos (e.g., movies, shows, etc.). Alternatively and/or additionally, a user may be required to watch and/or interact with the content item before the user can access content of a web page and/or video stream application, utilize resources of an application and/or play a game.

At 402, first event information associated with a plurality of events may be determined. The first event information may be used for identifying one or more fraudulent and/or anomalous entities using one or more of the techniques provided herein. The plurality of events may be associated with a plurality of entities. Each entity of the plurality of entities may be associated with one or more events of the plurality of events. In some examples, the plurality of events may correspond to events that occur within a first period of time (e.g., 12 hours, one day, two days, one week, etc.).

In some examples, the plurality of entities corresponds to internet resource-side (and/or publisher-side) entities and/or client-side entities. For example, an entity of the plurality of entities (and/or each entity of the plurality of entities) may correspond to (and/or may be identified by) at least one of one or more internet resources, such as at least one of one or more web pages, a website, an application (e.g., at least one of a mobile application, a client application, a gaming application, etc.), an application identifier of an application, a video streaming application (e.g., a CTV application), a video streaming application identifier (e.g., a CTV application identifier) of a video streaming application, a platform for accessing and/or presenting content (e.g., the content may comprise videos, articles, audio, etc.), one or more internet resource identifiers associated with one or more internet resources, a host device associated with one or more internet resources (e.g., the host device may comprise one or more computing devices, storage and/or a network configured to host the one or more internet resources), a host identifier of the host device, a domain (e.g., a domain name, a top-level domain, etc.) associated with one or more internet resources, an application identifier associated with one or more applications, a publisher identifier associated with a publisher of one or more internet resources, a seller (e.g., an advertisement space seller providing advertisement space on one or more internet resources in exchange for compensation), a seller identifier (e.g., an identifier of an advertisement space seller), a supply side platform (SSP) (e.g., an ad exchange), an SSP identifier, a client device, a device identifier of a client device, a network identifier (e.g., an Internet Protocol (IP) address), etc. Alternatively and/or additionally, an entity of the plurality of entities (and/or each entity of the plurality of entities) may correspond to (and/or may be identified by) a group of entities, such as an n-tuple comprising n types of entities and/or n types of entity identifiers. In an example, an entity of the plurality of entities (and/or each entity of the plurality of entities) may correspond to (and/or may be identified by) a group of entities comprising a seller and/or seller identifier, an SSP and/or SSP identifier and an application and/or application identifier (e.g., the entity may correspond to a 3-tuple comprising the seller and/or seller identifier, the SSP and/or SSP identifier and the application and/or application identifier).

In some examples, the first event information may be determined based upon network traffic associated with the plurality of entities (e.g., internet traffic of internet resources associated with the plurality of entities). In an example, the network traffic may comprise advertisement traffic associated with the plurality of entities.

A first entity of the plurality of entities is associated with one or more first internet resources. For example, the first entity may correspond to at least one of a website comprising the one or more first internet resources, an application (e.g., a video streaming application, such as a CTV application) comprising the one or more first internet resources, an owner of the one or more first internet resources, a domain associated with the one or more first internet resources, a host of the one or more first internet resources, an application that provides for access to the one or more first internet resources, a seller that sells advertisement space on the one or more first internet resources, an SSP that facilitates sales of advertisement space on the one or more first internet resources, etc. The first event information may be indicative of a first set of event information associated with the first entity. The first set of event information may be indicative of at least one of requests for content (e.g., advertisement requests), bid requests, bid responses, content item presentations (e.g., advertisement impressions), network identifiers, device identifiers, user agents, etc. associated with events in which at least one of a content item (e.g., an advertisement) is requested for presentation via an internet resource of the one or more first internet resources, an auction is performed to select a content item for presentation via an internet resource of the one or more first internet resources, a content item (e.g., an advertisement) is selected for presentation via an internet resource of the one or more first internet resources, a content item (e.g., an advertisement) is selected (e.g., an advertisement click) via an internet resource of the one or more first internet resources, etc. For example, the first set of event information may be determined by aggregating data, associated with the first entity (and/or the one or more first internet resources), collected by the content system (e.g., the data may be collected by a DSP of the content system). Alternatively and/or additionally, the first set of event information may be determined based upon network traffic (e.g., internet traffic, such as advertisement traffic) received and/or transmitted by the content system (e.g., the DSP of the content system).

In an example, one, some and/or all entities of the first plurality of entities correspond to video streaming applications (e.g., CTV applications). Alternatively and/or additionally, one, some and/or all entities of the first plurality of entities may correspond to other types of entities other than video streaming applications. Alternatively and/or additionally, one, some and/or all entities of the first plurality of entities may correspond to a same type of entity. Alternatively and/or additionally, the first plurality of entities may comprise different types of entities.

FIGS. 5A-5B illustrate one or more first events, of the plurality of events being performed and/or detected. FIG. 5A illustrates a first client device 500 (e.g., a smart TV, a smartphone, a laptop, a digital media player, etc.) presenting a first video 506 via a first internet resource (e.g., a first video streaming application) of the one or more first internet resources associated with the first entity of the plurality of entities. The one or more first events may be associated with the first entity and the first client device 500. In an example, the one or more first events may comprise one or more bid-time events and/or one or more post-bid events.

In some examples, an event of the one or more first events may correspond to the first client device 500 presenting the first video 506 via the first internet resource associated with the first entity. Alternatively and/or additionally, the first client device 500 and/or a server associated with the first internet resource may transmit a first request for content 504 to a server 502 associated with the content system. In an example, the first request for content 504 may correspond to a request to be presented with a content item (e.g., an advertisement) via the first internet resource (e.g., the first video streaming application). In an example, the first request for content 504 may be associated with a first bid request. For example, the first bid request may be comprised in the first request for content 504. In some examples, an event (e.g., a bid-time event) of the one or more first events may correspond to transmission of the first request for content 504 (and/or the first bid request) by the first client device 500 (and/or by the server associated with the first internet resource). In response to the first request for content 504 and/or the first bid request, a first bid response (indicative of one or more bid values, for example) may be generated and/or a first content item may be selected (by the content system, for example) for presentation via the first client device 500. In an example, the first content item may be selected for presentation via the first client device 500 based upon a determination that, among bid values associated with a plurality of content items participating in an auction associated with the first bid request, the first content item is associated with the highest bid value. In some examples, an event (e.g., a bid-time event) of the one or more first events may correspond to the first content item being selected for presentation via the first client device 500. In response to selecting the first content item, the first content item may be transmitted to the first client device 500 and/or presented via the first client device 500 (via the first internet resource, for example).

FIG. 5B illustrates the first content item (shown with reference number 512) being presented via the first client device 500. The first content item 512 may be a second video (e.g., a video advertisement). In some examples, an event (e.g., a post-bid event) of the one or more first events may correspond to the first content item 512 being presented via the first client device 500 (e.g., the event may correspond to a content item presentation, such as an advertisement impression). In an example, a skip selectable input 514 may be displayed. In response to a selection of the skip selectable input 514, the first content item 512 may stop being presented (prior to completion of playback of the first content item 512, for example) and/or playback of the first video 506 may be continued. In some examples, an event (e.g., a post-bid event) of the one or more first events may correspond to a selection of the skip selectable input 514. In some examples, an event (e.g., a post-bid event) of the one or more first events may correspond to the first content item 512 being selected via the first client device 500 (e.g., the event may correspond to a content item selection, such as an advertisement click).

In some examples, the first event information may comprise a plurality of sets of event information. A set of event information of the plurality of sets of event information (and/or each set of event information of the plurality of sets of event information) may be associated with an entity of the plurality of entities. For example, the first set of event information of the plurality of sets of event information may be associated with the first entity of the plurality of entities, a second set of event information of the plurality of sets of event information may be associated with a second entity of the plurality of entities, etc. In an example, the first set of event information may be indicative of first events (comprising the one or more first events, for example) associated with the first entity of the plurality of entities.

In an example, the first events associated with the first entity may comprise at least one of content item presentations (e.g., content item impressions) via the one or more first internet resources (e.g., presentations of advertisements, such as advertisement impressions, via the one or more first internet resources), content item selections (e.g., advertisement clicks) via the one or more first internet resources, a content item skip (e.g., advertisement skip, such as in response to a selection of a skip selectable input) by a client device via the one or more first internet resources, content being accessed by a client device via the one or more first internet resources, videos being played on a client device via the one or more first internet resources, video playback being stopped on a client device via the one or more first internet resources, etc.

At 404, a plurality of sets of event metrics, associated with the plurality of entities, may be determined based upon the first event information. For example, the first event information may be aggregated to determine the plurality of sets of event metrics associated with the plurality of entities. In some examples, an event metric of the plurality of sets of event metrics may be based upon network traffic associated with an entity of the plurality of entities, such as internet traffic (e.g., advertising traffic) and/or other type of network traffic associated with the entity.

In some examples, a set of event metrics of the plurality of sets of event metrics (and/or each set of event metrics of the plurality of sets of event metrics) may be associated with an entity of the plurality of entities. For example, a first set of event metrics of the plurality of sets of event metrics may be associated with the first entity of the plurality of entities, a second set of event metrics of the plurality of sets of event metrics may be associated with the second entity of the plurality of entities, etc.

In some examples, a set of event metrics of the plurality of sets of event metrics (and/or each set of event metrics of the plurality of sets of event metrics) may be determined based upon a set of event information of the plurality of sets of event information. For example, the first set of event metrics associated with the first entity may be determined based upon the first set of event information associated with the first entity, the second set of event metrics associated with the second entity may be determined based upon the second set of event information associated with the second entity, etc.

In some examples, a set of event metrics of the plurality of sets of event metrics (and/or each set of event metrics of the plurality of sets of event metrics) may comprise a measure of content item presentations (e.g., content item impressions, such as advertisement impressions) associated with an entity during the first period of time, a measure of content item selections (e.g., advertisement clicks) associated with an entity during the first period of time, a measure of bid requests (e.g., a measure of requests for content, such as a measure of requests for advertisements) associated with the entity during the first period of time, a measure of bid responses (e.g., a measure of responses to bid requests) associated with the entity during the first period of time, a measure of device identifiers of devices associated with content item presentations (e.g., content item impressions, such as advertisement impressions) associated with the entity during the first period of time, a measure of user agents (e.g., user agent identifiers) of bid requests associated with the entity during the first period of time, a measure of user identifiers (e.g., at least one of user accounts, usernames, an identifier of a cookie, etc.) of bid requests associated with the entity during the first period of time, a measure of network identifiers (e.g., IP addresses) of networks from which bid requests associated with the entity are received during the first period of time, a measure of internet service providers (ISPs) associated with the entity during the first period of time, and/or one or more video playback metrics associated with video playback associated with the entity (such as in an example in which the entity is associated with a video streaming application). In an example, the one or more video playback metrics may comprise at least one of a measure of video starts associated with the entity during the first period of time, a measure of video completions associated with the entity during the first period of time, a measure of instances, associated with the entity, in which a first proportion of a video (e.g., at least one of 25% of a video, 50% of a video, 75% of a video, etc.) is presented, and/or a measure of instances, associated with the entity, in which a second proportion of a video is presented. In an example, the one or more video playback metrics may comprise one or more video advertisement metrics. For example, the measure of video starts may correspond to a measure of video advertisement starts associated with the entity during the first period of time. Alternatively and/or additionally, the measure of video completions may correspond to a measure of video advertisement completions associated with the entity during the first period of time. Alternatively and/or additionally, the measure of instances, associated with the entity, in which the first proportion of a video is presented may correspond to a measure of instances in which the first proportion of a video advertisement is presented. Alternatively and/or additionally, the measure of instances, associated with the entity, in which the second proportion of a video is presented may correspond to a measure of instances in which the second proportion of a video advertisement is presented.

In some examples, the term “measure” as used herein may correspond to a quantity, a rate, an average and/or other metric. For example, a measure of content item presentations may correspond to a quantity of content item presentations (e.g., a total quantity of content item presentations during the first period of time). Alternatively and/or additionally, the measure of content item presentations may correspond to a rate of content item presentations per unit of time. In an example in which the unit of time is a day, the rate of content item presentations may correspond to an average quantity of content item presentations per day during the first period of time.

In an example, the first set of event metrics of the plurality of sets of event metrics may comprise a first measure of content item presentations (e.g., content item impressions, such as advertisement impressions) associated with the first entity during the first period of time. For example, the first measure of content item presentations may be a measure of content item presentations via the one or more first internet resources during the first period of time, such as a measure of advertisement presentations via the one or more first internet resources during the first period of time.

Alternatively and/or additionally, the first set of event metrics of the plurality of sets of event metrics may comprise a first measure of content item selections (e.g., content item clicks, such as advertisement clicks) associated with the first entity during the first period of time. For example, the first measure of content item selections may be a measure of content item selections via the one or more first internet resources during the first period of time, such as a measure of advertisement selections via the one or more first internet resources during the first period of time.

Alternatively and/or additionally, the first set of event metrics may comprise a first measure of bid requests associated with the first entity during the first period of time. For example, the first measure of bid requests may correspond to a measure of bid requests, associated with the one or more first internet resources, that are received (by the content system, for example) during the first period of time. For example, the first measure of bid requests may correspond to a measure of requests for content, associated with the one or more first internet resources, that are received (by the content system, for example) during the first period of time, wherein the requests for content comprise bid requests, and/or wherein the requests for content and/or the bid requests correspond to requests to be presented with content (e.g., advertisements) via the one or more first internet resources. For example, the requests for content may comprise the first request for content 504 and/or bid requests (counted in determining the first measure of bid requests) may comprise the first bid request.

Alternatively and/or additionally, the first set of event metrics may comprise a first measure of bid responses associated with the first entity during the first period of time. For example, the first measure of bid responses may correspond to a measure of bid responses, associated with the one or more first internet resources, that are provided in response to bid requests received (by the content system, for example) during the first period of time, wherein the bid requests are associated with requests to be presented with content (e.g., advertisements) via the one or more first internet resources.

Alternatively and/or additionally, the first set of event metrics may comprise a first measure of device identifiers associated with the first entity during the first period of time. For example, the first measure of device identifiers may correspond to a measure of device identifiers (e.g., distinct device identifiers) associated with content item presentations (e.g., advertisement impressions), via the one or more first internet resources, that occur during the first period of time. Alternatively and/or additionally, the first measure of device identifiers may correspond to a measure of device identifiers that are indicated by requests for content and/or bid requests that are received during the first period of time, wherein the requests for content and/or the bid requests correspond to requests to be presented with content (e.g., advertisements) via the one or more first internet resources. In an example, a device identifier may be an identification of a device from which a request for content (and/or a bid request) is received (by the content system, for example). For example, the request for content (and/or the bid request) may comprise an indication of the device identifier, wherein the content system may be configured to select content (e.g., an advertisement) for presentation via the device based upon the device identifier (such as based upon historical activity information associated with the device identifier). In an example, the device identifier may be an advertising device identifier used for selection of advertisements. The device identifier may be reset to a new device identifier using the device (such as via settings of the device). The feature of resetting device identifiers may be utilized by malicious entities for the purpose of hiding fraudulent activity. For example, malicious entities may regularly reset device identifiers of devices used to perform fraudulent activity (e.g., advertising fraud) to hide the fraudulent activity. Alternatively and/or additionally, malicious entities may use a plurality of device identifiers to counterfeit advertisement impressions. In some examples, device identifiers (counted in determining the first measure of device identifiers) may comprise a device identifier associated with the first client device 500, wherein the device identifier may be indicated by the first request for content 504 and/or the first bid request.

Alternatively and/or additionally, the first set of event metrics may comprise a first measure of user identifiers (e.g., at least one of user accounts, usernames, an identifier of a cookie, etc.) associated with the first entity during the first period of time. For example, the first measure of user identifiers may correspond to a measure of user identifiers (e.g., distinct user identifiers) associated with content item presentations (e.g., advertisement impressions), via the one or more first internet resources, that occur during the first period of time. Alternatively and/or additionally, the first measure of user identifiers may correspond to a measure of user identifiers that are indicated by requests for content and/or bid requests that are received during the first period of time, wherein the requests for content and/or the bid requests correspond to requests to be presented with content (e.g., advertisements) via the one or more first internet resources. In an example, a user identifier may be an identification of at least one of a user account, a username, a cookie, etc. of a device from which a request for content (and/or a bid request) is received (by the content system, for example). For example, the request for content (and/or the bid request) may comprise an indication of the user identifier, wherein the content system may be configured to select content (e.g., an advertisement) for presentation via the device based upon the user identifier (such as based upon historical activity information associated with the user identifier). In some examples, user identifiers (counted in determining the first measure of user identifiers) may comprise a user identifier associated with the first client device 500, wherein the user identifier may be indicated by the first request for content 504 and/or the first bid request.

Alternatively and/or additionally, the first set of event metrics may comprise a first measure of user agents (e.g., user agent identifiers) associated with the first entity during the first period of time. For example, the first measure of user agents may correspond to a measure of user agents (e.g., distinct user agents) associated with content item presentations (e.g., advertisement impressions), via the one or more first internet resources, that occur during the first period of time. Alternatively and/or additionally, the first measure of user agents may correspond to a measure of user agents that are indicated by requests for content and/or bid requests that are received during the first period of time, wherein the requests for content and/or the bid requests correspond to requests to be presented with content (e.g., advertisements) via the one or more first internet resources. In an example, a user agent may be an identification of a device type of a device from which a request for content (and/or a bid request) is received (by the content system, for example). For example, the request for content (and/or the bid request) may comprise an indication of the user agent. In some examples, malicious entities may use a plurality of user agents to counterfeit advertisement impressions. In some examples, user agents (counted in determining the first measure of user agents) may comprise a user agent associated with the first client device 500, wherein the user agent may be indicated by the first request for content 504 and/or the first bid request.

Alternatively and/or additionally, the first set of event metrics may comprise a first measure of network identifiers (e.g., IP addresses) associated with the first entity during the first period of time. For example, the first measure of network identifiers may correspond to a measure of network identifiers (e.g., distinct network identifiers) associated with content item presentations (e.g., advertisement impressions), via the one or more first internet resources, that occur during the first period of time. Alternatively and/or additionally, the first measure of network identifiers may correspond to a measure of network identifiers that are indicated by requests for content and/or bid requests that are received during the first period of time, wherein the requests for content and/or the bid requests correspond to requests to be presented with content (e.g., advertisements) via the one or more first internet resources. Alternatively and/or additionally, the first measure of network identifiers may correspond to a measure of network identifiers of networks (e.g., computer networks, such as at least one of household networks, workplace networks, etc.) from which requests for content and/or bid requests are received during the first period of time, wherein the requests for content and/or the bid requests correspond to requests to be presented with content (e.g., advertisements) via the one or more first internet resources. In some examples, network identifiers (counted in determining the first measure of network identifiers) may comprise a network identifier (e.g., an IP address) of a network to which the first client device 500 is connected when the first request for content 504 and/or the first bid request are transmitted and/or received.

Alternatively and/or additionally, the first set of event metrics may comprise a first measure of video starts (e.g., video start engagements) associated with the first entity during the first period of time. For example, the first measure of video starts may be a measure of video start engagements via the one or more first internet resources during the first period of time. A video start (e.g., a video start engagement) may correspond to playback of a video being started via an internet resource associated with the first entity. In some examples, the first measure of video starts may be associated with video advertisements. For example, the first measure of video starts may be a measure of video advertisement starts (e.g., video advertisement start engagements) associated with the first entity during the first period of time. For example, the measure of video advertisement starts may be a measure of video advertisement start engagements via the one or more first internet resources during the first period of time. A video advertisement start (e.g., a video advertisement start engagement) may correspond to playback of a video advertisement being started via an internet resource associated with the first entity.

Alternatively and/or additionally, the first set of event metrics may comprise a first measure of video completions (e.g., video completion engagements) associated with the first entity during the first period of time. For example, the first measure of video completions may be a measure of video completion engagements via the one or more first internet resources during the first period of time. A video completion (e.g., a video completion engagement) may correspond to playback of a video being completed via an internet resource associated with the first entity. In some examples, the first measure of video completions may be associated with video advertisements. For example, the first measure of video completions may be a measure of video advertisement completions (e.g., video advertisement completion engagements) associated with the first entity during the first period of time. For example, the measure of video advertisement completions may be a measure of video advertisement completion engagements via the one or more first internet resources during the first period of time. A video advertisement completion (e.g., a video advertisement completion engagement) may correspond to playback of a video advertisement being completed via an internet resource associated with the first entity.

Alternatively and/or additionally, the first set of event metrics may comprise a first measure of instances, associated with the first entity, in which the first proportion of a video is presented during the first period of time. For example, the first measure of instances may be a measure of instances in which at least the first proportion of a video is presented via the one or more first internet resources during the first period of time. In some examples, the first measure of instances may be associated with video advertisements. For example, the first measure of instances may correspond to a measure of instances, associated with the first entity, in which the first proportion of a video advertisement is presented during the first period of time. For example, the first measure of instances may be a measure of instances in which at least the first proportion of a video advertisement is presented via the one or more first internet resources during the first period of time.

Alternatively and/or additionally, the first set of event metrics may comprise a second measure of instances, associated with the first entity, in which the second proportion of a video is presented during the first period of time. For example, the second measure of instances may be a measure of instances in which at least the second proportion of a video is presented via the one or more first internet resources during the first period of time. In some examples, the second measure of instances may be associated with video advertisements. For example, the second measure of instances may correspond to a measure of instances, associated with the first entity, in which the second proportion of a video advertisement is presented during the first period of time. For example, the second measure of instances may be a measure of instances in which at least the second proportion of a video advertisement is presented via the one or more first internet resources during the first period of time.

In some examples, sets of event metrics of the plurality of sets of event metrics, other than the first set of event metrics, may comprise metrics of the same type as some and/or all metrics described with respect to the first set of event metrics.

FIG. 5C illustrates the plurality of sets of event metrics (shown with reference number 524), associated with the plurality of entities, being determined based upon the first event information (shown with reference number 520). The plurality of sets of event metrics 524 may be determined by a metrics determiner 522 (e.g., the first event information 520 may be input to the metrics determiner 522, and/or the metrics determiner 522 may determine the plurality of sets of event metrics 524 based upon the first event information 520). For example, the first set of event metrics (e.g., “Entity 1 Metrics”) associated with the first entity (e.g., “Entity 1”) may be determined based upon the first set of event information associated with the first entity, the second set of event metrics (e.g., “Entity 2 Metrics”) may be determined based upon the second set of event information associated with the second entity (e.g., “Entity 2”), etc.

At 406, a first plurality of combined metrics may be determined based upon the plurality of sets of event metrics 524. In some examples, a combined metric of the first plurality of combined metrics (and/or each combined metric of the first plurality of combined metrics) may be determined based upon a set of metrics of the plurality of sets of event metrics. For example, the first plurality of combined metrics may comprise at least one of a first combined metric, associated with the first entity, determined based upon at least two event metrics of the first set of event metrics associated with the first entity, a second combined metric, associated with the second entity, determined based upon at least two event metrics of the second set of event metrics associated with the second entity, etc.

In some examples, a combined metric of the first plurality of combined metrics (and/or each combined metric of the first plurality of combined metrics) may be determined by combining a metric of a first type and a metric of a second type. For example, one or more operations (e.g., mathematical operations) may be performed using the metric of the first type and the metric of the second type to determine the combined metric. In an example, the combined metric may be based upon and/or equal to a ratio of the metric of the first type to the metric of the second type (or a ratio of the metric of the second type to the metric of the first type). Alternatively and/or additionally, the combined metric may be based upon and/or equal to the metric of the first type divided by the metric of the second type (or the metric of the second type divided by the metric of the first type).

For example, the first combined metric associated with the first entity may be determined based upon a first metric of the first type and a second metric of the second type. The first metric and the second metric may be from the first set of event metrics associated with the first entity. One or more operations (e.g., mathematical operations) may be performed using the first metric and the second metric to determine the first combined metric associated with the first entity. In an example, the first combined metric may be based upon and/or equal to a ratio of the first metric to the second metric (or a ratio of the second metric to the first metric). Alternatively and/or additionally, the first combined metric may be based upon and/or equal to the first metric divided by the second metric (or the second metric divided by the first metric).

In an example, the first type of metric may correspond to a measure of user agents and the second type of metric may correspond to a measure of network identifiers. For example, a combined metric of the first plurality of combined metrics (and/or each combined metric of the first plurality of combined metrics) may be determined based upon a measure of user agents (e.g., as indicated by the plurality of sets of event metrics 524) associated with an entity and a measure of network identifiers (e.g., as indicated by the plurality of sets of event metrics 524) associated with the entity. For example, the first combined metric associated with the first entity may be determined based upon the first measure of user agents and the first measure of network identifiers. In an example, the first combined metric may be based upon and/or equal to a ratio of the first measure of user agents to the first measure of network identifiers (or a ratio of the first measure of network identifiers to the first measure of user agents). Alternatively and/or additionally, the first combined metric may be based upon and/or equal to the first measure of user agents divided by the first measure of network identifiers (or the first measure of network identifiers divided by the first measure of user agents). Accordingly, in some examples, the first combined metric may correspond to a measure of user agents per network identifier.

In an example, the first type of metric may correspond to a measure of device identifiers and the second type of metric may correspond to a measure of content item presentations (e.g., advertisement presentations). For example, a combined metric of the first plurality of combined metrics (and/or each combined metric of the first plurality of combined metrics) may be determined based upon a measure of device identifiers (e.g., as indicated by the plurality of sets of event metrics 524) associated with an entity and a measure of content item presentations (e.g., as indicated by the plurality of sets of event metrics 524) associated with the entity. For example, the first combined metric associated with the first entity may be determined based upon the first measure of device identifiers and the first measure of content item presentations. In an example, the first combined metric may be based upon and/or equal to a ratio of the first measure of device identifiers to the first measure of content item presentations (or a ratio of the first measure of content item presentations to the first measure of device identifiers). Alternatively and/or additionally, the first combined metric may be based upon and/or equal to the first measure of device identifiers divided by the first measure of content item presentations (or the first measure of content item presentations divided by the first measure of device identifiers). Accordingly, in some examples, the first combined metric may correspond to a measure of device identifiers per content item presentation (e.g., advertisement impression).

In an example, the first type of metric may correspond to a measure of video starts (e.g., video advertisement starts) and the second type of metric may correspond to a measure of video completions (e.g., video advertisement completions). For example, a combined metric of the first plurality of combined metrics (and/or each combined metric of the first plurality of combined metrics) may be determined based upon a measure of video starts (e.g., as indicated by the plurality of sets of event metrics 524) associated with an entity and a measure of video completions (e.g., as indicated by the plurality of sets of event metrics 524) associated with the entity. For example, the first combined metric associated with the first entity may be determined based upon the first measure of video starts and the first measure of video completions. In an example, the first combined metric may be based upon and/or equal to a ratio of the first measure of video starts to the first measure of video completions (or a ratio of the first measure of video completions to the first measure of video starts). Alternatively and/or additionally, the first combined metric may be based upon and/or equal to the first measure of video starts divided by the first measure of video completions (or the first measure of video completions divided by the first measure of video starts). Accordingly, in some examples, the first combined metric may correspond to a measure of video completions (e.g., advertisement video completions) per video starts (e.g., advertisement video starts).

Other examples of the first type of metric and the second type of metric are provided. In an example, the first type of metric may correspond to a measure of user agents and the second type of metric may correspond to a measure of bid requests. In another example, the first type of metric may correspond to a measure of device identifiers and the second type of metric may correspond to a measure of bid requests. In another example, the first type of metric may correspond to a measure of network identifiers and the second type of metric may correspond to a measure of bid requests. In another example, the first type of metric may correspond to a measure of bid requests and the second type of metric may correspond to a measure of user identifiers. In another example, the first type of metric may correspond to a measure of user agents and the second type of metric may correspond to a measure of user identifiers. In another example, the first type of metric may correspond to a measure of user agents and the second type of metric may correspond to a measure of user identifiers. In another example, the first type of metric may correspond to a measure of network identifiers and the second type of metric may correspond to a measure of content item presentations. In another example, the first type of metric may correspond to a measure of network identifiers and the second type of metric may correspond to a measure of device identifiers. In another example, the first type of metric may correspond to a measure of user agents and the second type of metric may correspond to a measure of content item presentations. In another example, the first type of metric may correspond to a measure of content item selections and the second type of metric may correspond to a measure of content item presentations. In another example, the first type of metric may correspond to a measure of user identifiers and the second type of metric may correspond to a measure of content item presentations. In another example, the first type of metric may correspond to a measure of user identifiers and the second type of metric may correspond to a measure of device identifiers. In another example, the first type of metric may correspond to a measure of user identifiers and the second type of metric may correspond to a measure of network identifiers. In another example, the first type of metric may correspond to a measure of user agents and the second type of metric may correspond to a measure of network identifiers. In another example, the first type of metric may correspond to a measure of content item selections and the second type of metric may be equal to a value (e.g., a constant value), such as 1 (e.g., the second type of metric may be substituted with the value). In another example, the first type of metric may correspond to a measure of content item presentations and the second type of metric may correspond to a measure of executed bids.

Alternatively and/or additionally, the first type of metric and the second type of metric may be another combination of types of metrics other than the examples described herein. For example, the first type of metric may be any type of metric of the plurality of sets of event metrics 524 and the second type of metric may be any type of metric of the plurality of sets of event metrics 524, wherein the first type of metric is different than the second type of metric. Alternatively and/or additionally, in some examples, the first type of metric or the second type of metric may be equal to a value (e.g., the first type of metric or the second type of metric may be substituted with the value), such as a constant value (e.g., a metric of the plurality of sets of event metrics 524 may be combined with the value to determine a combined metric of the first plurality of combined metrics). In an example, the value may be different than (and/or may not be based upon) metrics and/or types of metrics of the plurality of sets of event metrics 524. Alternatively and/or additionally, in some examples, more than two metrics (of more than two types of metrics) may be combined to determine a combined metric of the first plurality of combined metrics.

FIG. 5D illustrates the first plurality of combined metrics (shown with reference number 532), associated with the plurality of entities, being determined based upon the plurality of sets of event metrics 524. The first plurality of combined metrics 532 may be determined by a combined metrics determiner 530 (e.g., the plurality of sets of event metrics 524 may be input to the combined metrics determiner 530, and/or the combined metrics determiner 530 may determine the first plurality of combined metrics 532 based upon the plurality of sets of event metrics 524). For example, the first combined metric (e.g., “Entity 1 Combined Metric”) associated with the first entity (e.g., “Entity 1”) may be determined based upon the first set of event metrics (e.g., “Entity 1 Metrics”), the second combined metric (e.g., “Entity 2 Combined Metric”) associated with the second entity (e.g., “Entity 2”) may be determined based upon the second set of event metrics (e.g., “Entity 2 Metrics”), etc.

At 408, a first threshold metric associated with anomalous behavior may be determined based upon the first plurality of combined metrics 532. For example, the first threshold metric may be compared with a combined metric of the first plurality of combined metrics 532 to determine whether the combined metric is anomalous. That is, the first threshold metric may be configured to enable distinguishing between anomalous (e.g., atypical) combined metrics (that may be associated with and/or may be an indication of fraudulent (e.g., atypical) entity activity, for example) and non-anomalous (e.g., typical) combined metrics (that may be associated with and/or may be an indication of non-fraudulent (e.g., typical) entity activity, for example).

In some examples, the first threshold metric 542 corresponds to an upper combined metric boundary. For example, combined metrics that exceed the first threshold metric may be considered to be anomalous combined metrics (that may be associated with and/or may be an indication of fraudulent entity activity, for example) and combined metrics that are less than the first threshold metric may be considered to be non-anomalous (that may be associated with and/or may be an indication of normal and/or non-fraudulent entity activity, for example).

Alternatively and/or additionally, the first threshold metric 542 may correspond to a lower combined metric boundary. For example, combined metrics that are less than the first threshold metric may be considered to be anomalous combined metrics (that may be associated with and/or may be an indication of fraudulent entity activity, for example) and combined metrics that exceed the first threshold metric may be considered to be non-anomalous combined metrics (that may be associated with and/or may be an indication of normal and/or non-fraudulent entity activity, for example).

Alternatively and/or additionally, the first threshold metric 542 may comprise an upper combined metric boundary and a lower combined metric boundary.

In some examples, the first plurality of combined metrics 532 may be analyzed to determine the first threshold metric. For example, the first plurality of combined metrics 532 may be combined to determine the first threshold metric. In an example, one or more operations (e.g., mathematical operations) may be performed using the first plurality of combined metrics 532 to determine the first threshold metric.

In an example, a first value of a first percentile of the first plurality of combined metrics 532 may be determined. A second value of a second percentile of the first plurality of combined metrics 532 may be determined. The first threshold metric may be determined based upon the first value and/or the second value. FIG. 5E illustrates determination of the first threshold metric (shown with reference number 542). FIG. 5E includes a chart having a vertical axis corresponding to quantities of entities of the plurality of entities and a horizontal axis corresponding to combined metric values. The chart comprises a curve showing a quantity of entities, of the plurality of entities, per combined metric value. In an example shown in FIG. 5E, the first percentile is the 10th percentile of the first plurality of combined metrics 532 and/or the second percentile is the 90th percentile of the first plurality of combined metrics 532. Accordingly, the first value (shown with reference number 538) may correspond to a combined metric value, wherein about 10% of the first plurality of combined metrics 532 are lower than the first value 538 and/or about 90% of the first plurality of combined metrics 532 are higher than the first value 538. Alternatively and/or additionally, the second value (shown with reference number 540) may correspond to a combined metric value, wherein about 90% of the first plurality of combined metrics 532 are lower than the second value 540 and/or about 10% of the first plurality of combined metrics 532 are higher than the second value 540. In an example, the first value 538 and/or the second value 540 may be combined to determine the first threshold metric 542. For example, one or more operations (e.g., mathematical operations) may be performed using the first value 538 and/or the second value 540 to determine the first threshold metric 542. In an example, the first threshold metric 542 may be based upon and/or equal to T=V₂+k×D, where D=V₂−V₁, k is a value (e.g., a constant value, such as 1, 2, 3, 4, 5, etc.), V₁ is the first value 538 of the first percentile (e.g., the 10th percentile) and/or V₂ is the second value 540 of the second percentile (e.g., the 90th percentile). In the example shown in FIG. 5E, k is equal to 5. In the example shown in FIG. 5E, a combined metric exceeding the first threshold metric 542 may be considered to be anomalous (that may be associated with and/or may be an indication of fraudulent entity activity, for example) and/or a combined metric being less than the first threshold metric 542 may be considered to be non-anomalous (that may be associated with and/or may be an indication of normal and/or non-fraudulent entity activity, for example).

Alternatively and/or additionally, the first threshold metric 542 may be determined using one or more anomaly detection techniques, such as by applying an anomaly detection algorithm and/or using an anomaly detection model (e.g., a machine learning model for determining a threshold metric and/or applying the threshold metric to identify anomalous metrics). In an example, the one or more anomaly detection techniques may comprise applying an anomaly detection algorithm (e.g., at least one of isolation forest, local outlier factor, etc.) to determine the first threshold metric 542 based upon the first plurality of combined metrics 532.

Alternatively and/or additionally, the first threshold metric 542 may be determined based upon one or more known non-fraudulent entities (e.g., entities known to be non-fraudulent). For example, one or more combined metrics associated with the one or more known non-fraudulent entities may be determined (such as using one or more of the techniques discussed herein with respect to determining the first plurality of combined metrics 532). For example, the one or more combined metrics may be used as a reference point in determining the threshold combined metric 542. In an example in which the first threshold metric 542 corresponds to an upper combined metric boundary (e.g., where combined metrics exceeding the first threshold metric 542 are considered to be anomalous and/or combined metrics less than the first threshold metric 542 are considered to be non-anomalous), the first threshold metric 542 may be set to a value that is greater than (or equal to) a combined metric (e.g., a highest combined metric) of the one or more combined metrics associated with the one or more known non-fraudulent entities (e.g., the first threshold metric 542 may be determined based upon the highest combined metric of the one or more combined metrics). In an example in which the first threshold metric 542 corresponds to a lower combined metric boundary (e.g., where combined metrics less than the first threshold metric 542 are considered to be anomalous and/or combined metrics exceeding the first threshold metric 542 are considered to be non-anomalous), the first threshold metric 542 may be set to a value that is less than (or equal to) a combined metric (e.g., a lowest combined metric) of the one or more combined metrics associated with the one or more known non-fraudulent entities (e.g., the first threshold metric 542 may be determined based upon the lowest combined metric of the one or more combined metrics). Alternatively and/or additionally, the one or more combined metrics associated with the one or more known non-fraudulent entities may be combined to determine the first threshold metric 542. In an example, one or more operations (e.g., mathematical operations) may be performed using the one or more combined metrics to determine the first threshold metric 542.

Alternatively and/or additionally, the first threshold metric 542 may be determined based upon one or more known fraudulent entities (e.g., entities known to be fraudulent, such as entities known to be associated with fraudulent activity, such as advertising fraud). For example, one or more combined metrics associated with the one or more known fraudulent entities may be determined (such as using one or more of the techniques discussed herein with respect to determining the first plurality of combined metrics 532). For example, the one or more combined metrics may be used as a reference point in determining the threshold combined metric 542. In an example in which the first threshold metric 542 corresponds to an upper combined metric boundary (e.g., where combined metrics exceeding the first threshold metric 542 are considered to be anomalous and/or combined metrics less than the first threshold metric 542 are considered to be non-anomalous), the first threshold metric 542 may be set to a value that is less than (or equal to) a combined metric (e.g., a lowest combined metric) of the one or more combined metrics associated with the one or more known fraudulent entities (e.g., the first threshold metric 542 may be determined based upon the lowest combined metric of the one or more combined metrics). In an example in which the first threshold metric 542 corresponds to a lower combined metric boundary (e.g., where combined metrics less than the first threshold metric 542 are considered to be anomalous and/or combined metrics exceeding the first threshold metric 542 are considered to be non-anomalous), the first threshold metric 542 may be set to a value that is greater than (or equal to) a combined metric (e.g., a highest combined metric) of the one or more combined metrics associated with the one or more known fraudulent entities (e.g., the first threshold metric 542 may be determined based upon the highest combined metric of the one or more combined metrics). Alternatively and/or additionally, the one or more combined metrics associated with the one or more known fraudulent entities may be combined to determine the first threshold metric 542. In an example, one or more operations (e.g., mathematical operations) may be performed using the one or more combined metrics to determine the first threshold metric 542.

Alternatively and/or additionally, the first threshold metric 542 may be determined based upon historical combined metric data, such as combined metrics determined based upon historical event information associated with one or more entities.

In some examples, the first threshold metric 542 may not be based upon the first plurality of combined metrics 532. Alternatively and/or additionally, the first threshold metric 542 may be equal to a value (e.g., a fixed value) determined based upon the historical combined metric data, data determined using one or more anomaly detection techniques, one or more combined metrics associated with the one or more known fraudulent entities, one or more combined metrics associated with the one or more known non-fraudulent entities, and/or other information. The value of the first threshold metric 542 may or may not be determined based upon the first plurality of combined metrics 532. Alternatively and/or additionally, the value of the first threshold metric 542 may be manually input (e.g., via an interface associated with the content system).

Examples of the value of the first threshold metric 542 are provided. In an example in which combined metrics of the first plurality of combined metrics 532 are each equal to (and/or based upon) a measure of user agents divided by a measure of network identifiers, the value of the first threshold metric 542 may be less than 20 (or other value). In an example in which combined metrics of the first plurality of combined metrics 532 are each equal to (and/or based upon) a measure of device identifiers divided by a measure of content item presentations, the value of the first threshold metric 542 may be less than 10 (or other value). In an example in which combined metrics of the first plurality of combined metrics 532 are each equal to (and/or based upon) a measure of user agents divided by a measure of bid requests, the value of the first threshold metric 542 may be less than 10 (or other value). In an example in which combined metrics of the first plurality of combined metrics 532 are each equal to (and/or based upon) a measure of user agents divided by a measure of bid requests, the value of the first threshold metric 542 may be less than 10 (or other value). In an example in which combined metrics of the first plurality of combined metrics 532 are each equal to (and/or based upon) a measure of user agents divided by a measure of network identifiers, the value of the first threshold metric 542 may be less than 20 (or other value). In an example in which combined metrics of the first plurality of combined metrics 532 are each equal to (and/or based upon) a measure of device identifiers divided by a measure of bid requests (e.g., the combined metrics correspond to average distinct devices per bid request), the value of the first threshold metric 542 may be less than 10 (or other value, such as 1 or less than 1). In an example in which combined metrics of the first plurality of combined metrics 532 are each equal to (and/or based upon) a measure of network identifiers divided by a measure of bid requests (e.g., the combined metrics correspond to average IP addresses per bid request), the value of the first threshold metric 542 may be less than 10 (or other value, such as 1 or less than 1). In an example in which combined metrics of the first plurality of combined metrics 532 are each equal to (and/or based upon) a measure of device identifiers divided by a measure of network identifiers (e.g., the combined metrics correspond to average devices per IP address), the value of the first threshold metric 542 may be less than 20 (or other value). In an example in which combined metrics of the first plurality of combined metrics 532 are each equal to (and/or based upon) a measure of network identifiers divided by a measure of user identifiers (e.g., the combined metrics correspond to average IP addresses per device), the value of the first threshold metric 542 may be less than 20 (or other value). In an example in which combined metrics of the first plurality of combined metrics 532 are each equal to (and/or based upon) a measure of device identifiers divided by a measure of content item presentations (e.g., the combined metrics correspond to average distinct devices per content item presentation, such as per advertisement impression), the value of the first threshold metric 542 may be less than 10 (or other value, such as 1 or less than 1). In an example in which combined metrics of the first plurality of combined metrics 532 are each equal to (and/or based upon) a measure of network identifiers divided by a measure of content item presentations (e.g., the combined metrics correspond to average distinct IP addresses per content item presentation, such as per advertisement impression), the value of the first threshold metric 542 may be less than 10 (or other value, such as 1 or less than 1). In an example in which combined metrics of the first plurality of combined metrics 532 are each equal to (and/or based upon) a measure of device identifiers divided by a measure of network identifiers (e.g., the combined metrics correspond to average devices per IP address), the value of the first threshold metric 542 may be less than 20 (or other value). In an example in which combined metrics of the first plurality of combined metrics 532 are each equal to (and/or based upon) a measure of video starts divided by a measure of video completions, the value of the first threshold metric 542 may be less than 100 (or other value). In an example in which combined metrics of the first plurality of combined metrics 532 are each equal to (and/or based upon) a measure of content item selections divided by a measure of content item presentations, the value of the first threshold metric 542 may be less than 10 (or other value). In an example in which combined metrics of the first plurality of combined metrics 532 are each equal to (and/or based upon) a measure of network identifiers divided by a measure of user identifiers, the value of the first threshold metric 542 may be less than 20 (or other value). In an example in which combined metrics of the first plurality of combined metrics 532 are each equal to (and/or based upon) a measure of valid video starts divided by a measure of valid video completions, the value of the first threshold metric 542 may be less than 10 (or other value). In an example in which combined metrics of the first plurality of combined metrics 532 are each equal to (and/or based upon) a measure of content item selections divided by 1, the value of the first threshold metric 542 may be less than 100 (or other value). In an example in which combined metrics of the first plurality of combined metrics 532 are each equal to (and/or based upon) a measure of content item presentations divided by a measure of executed bids, the value of the first threshold metric 542 may be less than 500 (or other value, such as 1 or greater than 1).

In an example, combined metrics of the first plurality of combined metrics 532 are each based upon a measure of user agents and a measure of network identifiers (e.g., IP addresses) (e.g., the combined metrics may be equal to and/or based upon a measure of user agents divided by a measure of network identifiers). For example, a combined metric of the first plurality of combined metrics 542 may correspond to a measure of user agents per network identifier. In some examples, a typical household with a unique network identifier (e.g., IP address) may utilize up to a first quantity of devices that are used for accessing internet resources with which content items (e.g., advertisements) are presented. Comparatively few households have more than the first quantity of devices that are used for accessing internet resources with which content items (e.g., advertisements) are presented. Accordingly, using combined metrics corresponding to measures of user agents per network identifier may provide for more accurately identifying fraudulent entities performing fraudulent activity (e.g., advertising fraud). For example, the first threshold metric 542 may be set to a value that distinguishes between anomalous (e.g., atypical) measures of user agents per network identifier (that may be associated with and/or may be an indication of fraudulent (e.g., atypical) entity activity, for example) and non-anomalous (e.g., typical) measures of user agents per network identifier (that may be associated with and/or may be an indication of non-fraudulent (e.g., typical) entity activity, for example). In an example, a combined metric indicating a measure of user agents per network identifier that exceeds the first threshold metric 542 (e.g., the first threshold metric 542 may be based upon and/or equal to the first quantity of devices, since households typically have up to the first quantity of devices) may be anomalous and/or may be a strong indication that an entity associated with the combined metric is performing fraudulent activity. For example, the entity may employ devices (e.g., at least one of botnets, hacked client devices (e.g., zombie computers), click farms, fake websites, data centers, etc.) that utilize more user agents per network identifier (e.g., IP address) than a typical household.

In an example, combined metrics of the first plurality of combined metrics 532 are each based upon a measure of device identifiers and a measure of content item presentations (e.g., advertisement impressions) (e.g., the combined metrics may be equal to and/or based upon a measure of device identifiers divided by a measure of content item presentations). For example, a combined metric of the first plurality of combined metrics 542 may correspond to a measure of device identifiers per content item presentation. In some examples, fraudulent entities reset device identifiers of devices used to perform fraudulent activity at a higher rate than typical (e.g., non-fraudulent) users. For example, fraudulent entities may regularly reset device identifiers of devices used to perform fraudulent activity (e.g., advertising fraud) to hide the fraudulent activity. Accordingly, using combined metrics corresponding to measures of device identifiers per content item presentation may provide for more accurately identifying fraudulent entities performing fraudulent activity (e.g., advertising fraud). For example, the first threshold metric 542 may be set to a value that distinguishes between anomalous (e.g., atypical) measures of device identifiers per content item presentation (that may be associated with and/or may be an indication of fraudulent (e.g., atypical) entity activity, for example) and non-anomalous (e.g., typical) measures of device identifiers per content item presentation (that may be associated with and/or may be an indication of non-fraudulent (e.g., typical) entity activity, for example). In an example, a combined metric indicating a measure of device identifiers per content item presentation that exceeds the first threshold metric 542 may be anomalous and/or may be a strong indication that an entity associated with the combined metric is trying to hide fraudulent activity by regularly resetting device identifiers of devices (e.g., at least one of botnets, hacked client devices (e.g., zombie computers), click farms, fake websites, data centers, etc.) that are used to perform the fraudulent activity.

In an example, combined metrics of the first plurality of combined metrics 532 are each based upon a measure of video starts (e.g., advertisement video starts) and a measure of video completions (e.g., advertisement video completions) (e.g., the combined metrics may be equal to and/or based upon a measure of video completions divided by a measure of video starts). For example, a combined metric of the first plurality of combined metrics 542 may correspond to a measure of video completions per video start. Typically, video completions cannot exceed video starts. Accordingly, using combined metrics corresponding to measures of video completions per video start may provide for more accurately identifying fraudulent entities performing fraudulent activity (e.g., advertising fraud). For example, the first threshold metric 542 may be set to a value that distinguishes between anomalous (e.g., atypical) measures of video completions per video start (that may be associated with and/or may be an indication of fraudulent (e.g., atypical) entity activity, for example) and non-anomalous (e.g., typical) measures of video completions per video start (that may be associated with and/or may be an indication of non-fraudulent (e.g., typical) entity activity, for example). In an example, a combined metric indicating a measure of video completions per video start that exceeds the first threshold metric 542 (e.g., less than 10 or other value) may be anomalous and/or may be a strong indication that an entity associated with the combined metric is performing fraudulent activity using devices (e.g., at least one of botnets, hacked client devices (e.g., zombie computers), click farms, fake websites, data centers, etc.) that fraudulently report more video completions than video starts.

At 410, one or more first entities of the plurality of entities may be determined to be fraudulent (e.g., the one or more first entities may be determined to be associated with fraudulent activity). For example, the one or more first entities may be determined to be fraudulent based upon the first threshold metric 542 and one or more first combined metrics, of the first plurality of combined metrics 532, associated with the one or more first entities. For example, the one or more first entities of the plurality of entities may be determined to be fraudulent based upon a determination that the one or more first combined metrics meet the first threshold metric 542. In an example, the first plurality of combined metrics 532 may be compared with the first threshold metric 542 to identify the one or more first combined metrics, associated with the one or more first entities, that meet the first threshold metric 542.

In some examples, the one or more first combined metrics may be determined to be anomalous based upon the one or more first combined metrics meeting the first threshold metric 542. The one or more first entities may be determined to be fraudulent based upon the determination that the one or more first combined metrics are anomalous.

In an example (such as where the first threshold metric 542 corresponds to an upper combined metric boundary), the one or more first combined metrics may be determined to meet the first threshold metric 542 (and/or the one or more first combined metrics may be determined to be anomalous and/or the one or more first entities may be determined to be fraudulent) based upon a determination that the one or more first combined metrics exceed the first threshold metric 542.

In an example (such as where the first threshold metric 542 corresponds to a lower combined metric boundary), the one or more first combined metrics may be determined to meet the first threshold metric 542 (and/or the one or more first combined metrics may be determined to be anomalous and/or the one or more first entities may be determined to be fraudulent) based upon a determination that the one or more first combined metrics are less than the first threshold metric 542.

Alternatively and/or additionally, in some examples, the first threshold metric 542 may comprise a soft threshold, such as a range from a lower threshold value to an upper threshold value. In some examples, a combined metric may be determined to be anomalous and/or an entity associated with the combined metric may be determined to be fraudulent based upon a determination that the combined metric exceeds the upper threshold value (such as where the upper threshold value corresponds to an upper combined metric boundary) or a determination that the combined metric is less than the lower threshold value (such as where the lower threshold value corresponds to a lower combined metric boundary). Alternatively and/or additionally, if the combined metric is within the range, other information may be analyzed to determine whether the entity is a fraudulent entity. For example, the other information may comprise at least one of one or more other combined metrics associated with the entity, one or more other threshold metrics associated with the one or more other combined metrics, a quantity of times that the entity has been determined to be fraudulent, a duration of time since a time in which the entity has most recently been determined to be fraudulent, etc. Whether the entity is a fraudulent entity may be determined based upon the combined metric being within the range and the other information. For example, the entity may be determined to be fraudulent based upon a determination that the combined metric is within the range and at least one of the quantity of times exceeds a threshold quantity of times, the duration of time is less than a threshold duration, etc. Alternatively and/or additionally, the entity may be determined to not be fraudulent based upon a determination that the combined metric is within the range and at least one of the quantity of times is less than a threshold quantity of times, the duration of time is less than a threshold duration, etc.

In some examples, each combined metric of the first plurality of combined metrics 532 corresponds to a first type of combined metric, and the first plurality of combined metrics 532 are used for determining whether entities of the plurality of entities are fraudulent. That is, in some examples, combined metrics of merely a single type (e.g., the first type of combined metric) may be used for determining (using one or more of the techniques provided herein, for example) whether entities of the plurality of entities are fraudulent.

In some examples, a plurality of types of combined metrics may be used for determining whether entities of the plurality of entities are fraudulent. For example, for each type of combined metrics of the plurality of types of combined metrics, a plurality of combined metrics associated with the plurality of entities may be determined. For example, a plurality of sets of combined metrics associated with the plurality of entities may be determined. The plurality of sets of combined metrics may comprise at least one of a first set of combined metrics comprising the first plurality of combined metrics 532 corresponding to the first type of combined metric of the plurality of types of combined metrics, a second set of combined metrics comprising a plurality of combined metrics corresponding to a second type of combined metric of the plurality of types of combined metrics, a third set of combined metrics comprising a plurality of combined metrics corresponding to a third type of combined metric of the plurality of types of combined metrics, etc. In some examples, a plurality of threshold metrics associated with the plurality of types of combined metrics may be determined. For example, for each type of combined metric of the plurality of types of combined metrics, a threshold metric may be determined for comparison with combined metrics corresponding to the type of combined metric. For example, the plurality of threshold metrics may comprise the first threshold metric 542 for comparison with combined metrics of the first plurality of combined metrics 532, a second threshold metric for comparison with combined metrics of the second set of combined metrics, a third threshold metric for comparison with combined metrics of the third set of combined metrics, etc.

In some examples, types of combined metrics of the plurality of types of combined metrics are different from each other. For example, a first set of types of metrics (of the plurality of sets of event metrics 524) may be used to determine combined metrics of the first plurality of combined metrics 532 corresponding to the first type of combined metric, a second set of types of metrics (of the plurality of sets of event metrics 524) may be used to determine combined metrics of the second set of combined metrics corresponding to the second type of combined metric, and/or a third set of types of metrics (of the plurality of sets of event metrics 524) may be used to determine combined metrics of the third set of combined metrics corresponding to the third type of combined metric. In an example, the first set of types of metrics may comprise the first type of metric and the second type of metric, the second set of types of metrics may comprise a third type of metric and a fourth type of metric, and/or the third set of types of metrics may comprise a fifth type of metric and a sixth type of metric.

In some examples, a set of combined metrics of the plurality of sets of combined metrics (other than the first plurality of combined metrics 532) may be determined using one or more of the techniques provided herein with respect to determining the first plurality of combined metrics 532. Alternatively and/or additionally, a set of combined metrics of the plurality of sets of combined metrics (other than the first plurality of combined metrics 532) may have one or more characteristics of one or more examples provided herein with respect to the first plurality of combined metrics 532. Alternatively and/or additionally, examples provided herein with respect to the first plurality of combined metrics 532 may be applied as examples of a set of combined metrics of the plurality of sets of combined metrics (other than the first plurality of combined metrics 532). For example, examples provided herein of types of metrics that can be used to determine the first plurality of combined metrics 532 may be applied as examples of types of metrics that are used to determine a set of combined metrics of the plurality of sets of combined metrics (other than the first plurality of combined metrics 532). Alternatively and/or additionally, a threshold metric of the plurality of threshold metrics (other than the first threshold metric 542) may be determined using one or more of the techniques provided herein with respect to determining the first threshold metric 542. Alternatively and/or additionally, examples (e.g., example ranges of the first threshold metric 542) provided herein with respect to the first threshold metric 542 may be applied as examples of a threshold metric of the plurality of threshold metrics (other than the first threshold metric 542).

In an example, the first set of types of metrics (corresponding to metrics used to determine combined metrics of the first plurality of combined metrics 532) may comprise the first type of metric that corresponds to a measure of user agents and the second type of metric that corresponds to a measure of network identifiers. Alternatively and/or additionally, the second types of metrics (corresponding to metrics used to determine combined metrics of the second set of combined metrics) may comprise the third type of metric that corresponds to a measure of device identifiers and the fourth type of metric that corresponds to a measure of content item presentations. Alternatively and/or additionally, the third types of metrics (corresponding to metrics used to determine combined metrics of the third set of combined metrics) may comprise the fifth type of metric that corresponds to a measure of video starts (e.g., video advertisement starts) and the sixth type of metric that corresponds to a measure of video completions (e.g., video advertisement completions).

Alternatively and/or additionally, other combinations of types of metrics (other than the examples described herein) may be used to determine one or more sets of combined metrics of the plurality of sets of combined metrics. For example, combinations of any types of metric of the plurality of sets of event metrics 524 (and/or any value, such as a constant value) may be used to determine a set of combined metrics for use in determining whether an entity is fraudulent. Alternatively and/or additionally, in some examples, a type of metric of the first types of metrics, a type of metric of the second types of metrics, and/or a type of metric of the third types of metrics may be equal to a value, such as a constant value (e.g., a type of metric of the first types of metrics, a type of metric of the second types of metrics, and/or a type of metric of the third types of metrics may be substituted with the value). In an example, the value may be different than (and/or may not be based upon) metrics and/or types of metrics of the plurality of sets of event metrics 524. Alternatively and/or additionally, in some examples, more than two types of metrics may be combined to determine a combined metric for use in determining whether an entity is fraudulent.

In an example, an entity may be determined to be fraudulent based upon a determination that a quantity of anomalous combined metrics associated with the entity (e.g., combined metrics, associated with the entity, that each meet a corresponding threshold metric) meets a threshold quantity of anomalous combined metrics (e.g., the threshold quantity of anomalous combined metrics may be 1, 2, 3, etc.). In an example, the plurality of sets of combined metrics may comprise multiple combined metrics associated with an entity of the plurality of entities, wherein each combined metric of the multiple combined metrics corresponds to a type of combined metric of the plurality of types of combined metrics. For example, the multiple combined metrics may comprise at least one of a third combined metric (of the first plurality of combined metrics 532) corresponding to the first type of combined metric, a fourth combined metric (of the second set of combined metrics) corresponding to the second type of combined metric, a fifth combined metric (of the third set of combined metrics) corresponding to the third type of combined metric, etc. The multiple combined metrics may be compared with corresponding threshold metrics of the plurality of threshold metrics, respectively (e.g., at least one of the third combined metric may be compared with the first threshold metric 542 corresponding to the first type of combined metric, the fourth combined metric may be compared with the second threshold metric corresponding to the second type of combined metric, the fifth combined metric may be compared with the third threshold metric corresponding to the third type of combined metric, etc.) to identify one or more combined metrics, of the multiple combined metrics associated with the entity, that meet one or more corresponding threshold metrics of the plurality of threshold metrics (e.g., the one or more combined metrics are determined to be anomalous). The entity may be determined to be fraudulent based upon a determination that the one or more combined metrics (e.g., anomalous combined metrics) meet the threshold quantity of anomalous combined metrics. In an example, the threshold quantity of anomalous combined metrics may be 1, and thus, the entity may be determined to be fraudulent based upon a determination that at least one combined metric of the multiple combined metrics associated with the entity is determined to be anomalous. In an example, the threshold quantity of anomalous combined metrics may be 2, and thus, the entity may be determined to be fraudulent based upon a determination that at least two combined metrics of the multiple combined metrics associated with the entity are determined to be anomalous.

Alternatively and/or additionally, an entity may be determined to be fraudulent using one or more anomaly detection techniques, such as by applying an anomaly detection algorithm and/or using an anomaly detection model. In an example, the one or more anomaly detection techniques may comprise applying an anomaly detection algorithm (e.g., at least one of isolation forest, local outlier factor, etc.) to determine, based upon the plurality of sets of combined metrics, whether the entity is a fraudulent entity associated with fraudulent activity.

In some examples, the content system may control transmission and/or reception of data (such as transmission of content items) based upon identification of fraudulent entities, for example the one or more first entities identified using one or more of the techniques described with respect to the method 400 of FIG. 4 and/or the system 501 of FIGS. 5A-5E.

In some examples, a second request for content associated with a second client device and/or a second internet resource may be received by the content system. For example, the second request for content may be a request for the content system to provide a content item (e.g., an advertisement, an image, a link, a video, etc.) for presentation via the second client device using the second internet resource.

In some examples, a third entity, of the plurality of entities, associated with the second internet resource may be determined based upon the second request for content. For example, the second request for content may comprise an indication of the third entity. The third entity may be associated with one or more second internet resources comprising the second internet resource. For example, the third entity may correspond to at least one of a website comprising the one or more second internet resources, an application (e.g., a video streaming application, such as a CTV application) comprising the one or more second internet resources, an owner of the one or more second internet resources, a domain associated with the one or more second internet resources, a host of the one or more second internet resources, an application that provides for access to the one or more second internet resources, a seller that sells advertisement space on the one or more second internet resources, an SSP that facilitates sales of advertisement space on the one or more second internet resources, etc.

In some examples, the one or more first entities may comprise the third entity. For example, the third entity may be determined to be fraudulent (e.g., the third entity may be determined to be associated with fraudulent activity). In some examples, a content item associated with the second request for content may not be transmitted to the second client device based upon the determination that the third entity is fraudulent. For example, the determination that the third entity is fraudulent may correspond to a determination that the third entity (e.g., the one or more second internet resources) is being used (in conjunction with various devices, for example) for performance of fraudulent activity, such as advertising fraud, and/or that reception of the second request for content may be a result of such fraudulent activity.

Alternatively and/or additionally, entities (e.g., the one or more first entities) that are determined to be fraudulent may be flagged as fraudulent for a defined duration of time (e.g., 1 week, 2 weeks, etc.). For example, the one or more first entities (comprising the third entity) may be flagged as fraudulent for a second period of time (corresponding to the defined duration of time) in response to determining that the one or more first entities are fraudulent. For example, an entity flagged as fraudulent may be included in a fraud list, and/or may remain on the fraud list for the defined duration of time. For example, in response to determining that the one or more first entities are fraudulent, the one or more first entities may be added to the fraud list and/or may remain on the fraud list for the second period of time.

In some examples, when the third entity is flagged as fraudulent (e.g., when the third entity is included in the fraud list), content items (e.g., advertisements) may not be transmitted to client devices associated with the third entity (e.g., when the third entity is flagged as fraudulent, no content item may be transmitted to devices for presentation via the one or more second internet resources associated with the third entity). Alternatively and/or additionally, in response to the third entity being flagged as fraudulent (e.g., in response to the third entity being included in the fraud list), the content system may reduce an amount of content items (e.g., advertisements) presented via the one or more second internet resources associated with the third entity. For example, prior to the third entity being flagged as fraudulent, the content system may provide a first quantity of content items (e.g., advertisements) per unit of time via the one or more second internet resources associated with the third entity. When the third entity is flagged as fraudulent (e.g., when the third entity is included in the fraud list), the content system may provide a second quantity of content items (e.g., advertisements) per unit of time via the one or more second internet resources associated with the third entity, wherein the second quantity of content items per unit of time is less than the first quantity of content items per unit of time. For example, when the third entity is flagged as fraudulent (e.g., when the third entity is included in the fraud list), the content system may restrict content items being provided via the one or more second internet resources associated with the third entity to at most a maximum quantity of content items per unit of time (e.g., the content system may not present more than the maximum quantity of content items per unit of time via the one or more second internet resources associated with the third entity when the third entity is flagged as fraudulent).

In an example, the second request for content associated with the second client device may be received during the second period of time during which the third entity is flagged as fraudulent (e.g., included in the fraud list). In some examples, a content item associated with the second request for content may not be transmitted to the second client device based upon a determination that the third entity is flagged as fraudulent (e.g., based upon a determination that the third entity is included in the fraud list). For example, in response to receiving the second request for content, fraudulence information (e.g., information comprising the fraud list and/or indications of one or more entities that are flagged as fraudulent) may be analyzed to determine whether the third entity is flagged as fraudulent, and a content item may not be provided to the second client device in response to the second request for content based upon the determination that the third entity is flagged as fraudulent.

In some examples, in response to completion of the second period of time, the third entity may be removed from the fraud list (and/or may be no longer be flagged as fraudulent). For example, in response to completion of the second period of time, the content system may increase a quantity of content items (e.g., advertisements) per unit of time that are provided for presentation via the one or more second internet resources associated with the third entity. In some examples, after the second period of time (e.g., when the third entity is not flagged as fraudulent and/or is not included in the fraud list), in response to receiving a request for content associated with the second internet resource, the content system may provide a content item for presentation via the second internet resource (e.g., the content system may transmit the content item to a client device associated with the request for content) based upon the third entity associated with the second internet resource not being flagged as fraudulent and/or not being included in the fraud list when the request for content is received.

Alternatively and/or additionally, a plurality of fraud risk scores associated with the plurality of entities may be determined. In some examples, the plurality of fraud risk scores may be determined based upon the first plurality of combined metrics 532. Alternatively and/or additionally, in an example in which multiple types of combined metrics are determined for the plurality of entities, the plurality of fraud risk scores may be determined based upon the plurality of sets of combined metrics. For example, a first fraud risk score associated with the third entity may be determined based upon a combined metric, of the first plurality of combined metrics 532, associated with the third entity. Alternatively and/or additionally, the first fraud risk score may be determined based upon multiple combined metrics, of the plurality of sets of combined metrics, associated with the third entity. For example, combined metrics of the multiple combined metrics may be combined to determine the first fraud risk score. In an example, one or more operations (e.g., one or more mathematical operations) may be performed using the multiple combined metrics to determine the first fraud risk score. In an example, the multiple combined metrics (and/or values determined based upon the multiple combined metrics) may be averaged to determine an average, wherein the first fraud risk score may be based upon and/or equal to the average. Alternatively and/or additionally, the first fraud risk score may be determined based upon a quantity of times that the third entity has been determined to be fraudulent (e.g., a quantity of times that the third entity has been flagged as fraudulent and/or a quantity of times that the third entity has been added to the fraud list). In an example, a higher value of the quantity of times may correspond to a higher value of the first fraud risk score. Alternatively and/or additionally, the first fraud risk score may be determined based upon a duration of time since a time in which the third entity has most recently been determined to be fraudulent. In an example, a lower value of the duration of time may correspond to a higher value of the first fraud risk score.

In some examples, whether the third entity is fraudulent may be determined based upon the first fraud risk score. For example, the first fraud risk score may be compared with a threshold fraud risk score to determine whether the third entity is fraudulent. In some examples, the threshold fraud risk score may be determined (based upon the plurality of fraud risk scores, for example) using one or more of the techniques provided herein with respect to determining the first threshold metric 542 (based upon the first plurality of combined metrics 532, for example). In some examples, the third entity may be determined to be fraudulent (and/or the third entity may be flagged as fraudulent and/or included in the fraud list) based upon a determination that the first fraud risk score associated with the third entity meets (e.g., exceeds) the threshold fraud risk score.

Alternatively and/or additionally, a duration of a period of time in which the third entity is flagged as fraudulent and/or included in the fraud list may be determined based upon the first fraud risk score. For example, a higher value of the first fraud risk score may correspond to a longer duration of the period of time.

Alternatively and/or additionally, the maximum quantity of content items per unit of time (to which the content system restricts and/or limits content items provided for presentation via the one or more second internet resources associated with the third entity when the third entity is flagged as fraudulent) may be determined based upon the first fraud risk score. For example, a higher value of the first fraud risk score may correspond to a smaller value of the maximum quantity of content items per unit of time. That is, the higher the fraud risk score, the less content items the content system provides for presentation via the one or more second internet resources associated with the third entity.

It may be appreciated that determining the first fraud risk score based upon one or more combined metrics associated with the third entity, based upon the quantity of times that the third entity has been determined to be fraudulent and/or based upon the duration of time since the time in which the third entity has most recently been determined to be fraudulent, and/or controlling the duration of the period of time and/or the maximum quantity of content items per unit of time based upon the first fraud risk score, provides for more accurate and/or precise control of transmission of content by the content system. For example, entities that are associated with a higher level of fraudulent behavior and/or that are more likely to continue engaging in fraudulent behavior may have higher fraud risk scores, and thus may be flagged as fraudulent for longer periods of time and/or may be provided with fewer content items (e.g., advertisements) by the content system.

In some examples, one or more entities that fail to meet one or more criteria may be excluded from the plurality of entities (e.g., using a quantification method, such as a Boolean mask). For example, the one or more criteria may correspond to at least one of a minimum measure of bid requests, a minimum measure of content item presentations, etc. In an example, an entity may be excluded from the plurality of entities (and/or metrics associated with the entity may not be used to determine whether the entity is fraudulent) based upon a determination that one or more metrics associated with the entity do not meet the criteria (e.g., at least one of a measure of bid requests associated with the entity is less than the minimum measure of bid requests, a measure of content item presentations associated with the entity is less than the minimum measure of content item presentations, etc.).

In some examples, one or more second entities of the plurality of entities, that would otherwise be flagged as fraudulent entities and/or included in the fraud list based upon one or more combined metrics and/or one or more fraud risk scores using one or more of the techniques herein, may not be flagged as fraudulent entities and/or may not be included in the fraud list. For example, an entity of the one or more second entities may not be flagged as a fraudulent entity and/or may not be included in the fraud list based upon a determination that a quantity of times that the entity has been determined to be fraudulent is less than a threshold quantity of times. Alternatively and/or additionally, an entity of the one or more second entities may not be flagged as a fraudulent entity and/or may not be included in the fraud list based upon a determination that a duration of time, since a time in which the entity has most recently been determined to be fraudulent, exceeds a threshold duration of time. Alternatively and/or additionally, an entity of the one or more second entities may not be flagged as a fraudulent entity and/or may not be included in the fraud list based upon a determination that the entity is a known non-fraudulent entity. For example, it may be determined that the entity is a known non-fraudulent entity based upon a set of known non-fraudulent entities comprising the entity. For example, the set of known non-fraudulent entities may comprise one or more entities received via a manual bypass interface (e.g., the manual bypass interface may be utilized to avoid falsely flagging entities that are known to not be fraudulent).

In some examples, a fraudulence identification process may be performed automatically and/or periodically (e.g., twice per day, once per day, once per week, etc.) using one or more of the techniques herein to automatically check whether entities (of the plurality of entities, for example) are associated with fraudulent activity and/or to automatically identify and/or flag fraudulent entities (e.g., automatically add newly identified fraudulent entities to the fraud list, for example).

An embodiment of identifying fraudulent entities is illustrated by an example method 450 of FIG. 4B. The content system for presenting content via devices may be provided. At 452, first event information associated with a plurality of events within a period of time may be determined. The plurality of events may be associated with a first entity. At 454, a set of event metrics, associated with the first entity, may be determined based upon the first event information. For example, the set of event metrics may be determined using one or more of the techniques provided herein with respect to FIG. 4 and/or FIGS. 5A-5E for determining the plurality of sets of event metrics 524. At 456, a first combined metric may be determined based upon at least two metrics of the set of event metrics. For example, the first combined metric may be determined using one or more of the techniques provided herein with respect to FIG. 4 and/or FIGS. 5A-5E for determining the first plurality of combined metrics 532. At 458, whether the first entity is fraudulent may be determined based upon the first combined metric and a threshold metric associated with anomalous behavior. For example, the threshold metric may be determined using one or more of the techniques provided herein with respect to FIG. 4 and/or FIGS. 5A-5E for determining the first threshold metric 542. Alternatively and/or additionally, whether the first entity is fraudulent may be determined using one or more of the techniques provided herein with respect to FIG. 4 and/or FIGS. 5A-5E for determining whether entities of the plurality of entities are fraudulent. In an example, one or more combined metrics (e.g., the first combined metric and/or one or more other combined metrics) associated with the first entity may be compared with one or more threshold metrics (e.g., the threshold metric and/or one or more other threshold metrics) to determine whether the first entity is a fraudulent entity (e.g., an entity associated with fraudulent activity, such as advertising fraud).

It may be appreciated that the disclosed subject matter may prevent fraudulent activity, including, but not limited to, advertising fraud. For example, employing one or more of the techniques presented herein, such as at least one of determining combined metrics associated with entities, comparing the combined metrics with threshold metrics, etc. results in accurate identification of fraudulent entities associated with fraudulent activity. The fraudulent entities identified using one or more of the techniques presented herein may include entities that otherwise may have gone undetected using other systems. Further, using one or more of the techniques herein, fraudulent entities associated with fraudulent activity (e.g., advertising fraud) performed using video streaming applications (e.g., CTV applications) may be automatically detected with increased accuracy, increased recall, lower false positive rates and/or less effort (e.g., less manual intervention), whereas other fraud detection systems that attempt to identify fraudulent entities associated with fraudulent activity performed using video streaming applications have high false positive rates, low recall and require frequent manual intervention. Accordingly, it may be necessary to use one or more of the techniques herein to identify fraudulent entities. Thus, by implementing one or more of the techniques herein, it may be more difficult for a fraudulent entity to perform fraudulent activity without being detected.

Further, fraudulent entities may be discouraged from performing malicious actions (e.g., using one or more automated operation functionalities, hacking techniques, malware, etc.) to control client devices for transmission of advertisement requests because, by implementing one or more of the techniques presented herein, it is more difficult for an entity to successfully control a client device for transmission of a fraudulent advertisement request without being detected as a fraudulent entity.

Implementation of at least some of the disclosed subject matter may lead to benefits including, but not limited to, a reduction in transmission of fraudulent advertisement requests (and/or a reduction in bandwidth) (e.g., as a result of discouraging fraudulent entities from performing malicious actions to control client devices for transmission of advertisement requests).

Alternatively and/or additionally, implementation of at least some of the disclosed subject matter may lead to benefits including a reduction in transmission of content items based upon fraudulent advertisement requests (and/or a reduction in bandwidth) (e.g., as a result of identifying a fraudulent entity associated with fraudulent activity, as a result of controlling, such as restricting, transmission of data, such as content items and/or advertisements, to devices associated with the fraudulent entity based upon the identification of the fraudulent entity, etc.).

Alternatively and/or additionally, implementation of at least some of the disclosed subject matter may lead to benefits including preventing fraudulent entities from receiving compensation for performing fraudulent activity (e.g., as a result of identifying a fraudulent entity associated with fraudulent activity, as a result of controlling, such as restricting, transmission of data, such as content items and/or advertisements, to devices associated with the fraudulent entity based upon the identification of the fraudulent entity, etc.).

Alternatively and/or additionally, implementation of at least some of the disclosed subject matter may lead to benefits including a reduction in instances that client devices are hacked and/or controlled for transmission of fraudulent advertisement requests (e.g., as a result of discouraging fraudulent entities from performing malicious actions to control client devices for transmission of fraudulent advertisement requests).

Alternatively and/or additionally, implementation of at least some of the disclosed subject matter may lead to benefits including reducing unauthorized access of client devices and/or the content system (e.g., as a result of discouraging fraudulent entities from performing malicious actions to control client devices for transmission of fraudulent advertisement requests and/or as a result of identifying a fraudulent entity associated with fraudulent activity and/or controlling, such as restricting, transmission of data, such as content items and/or advertisements, to devices associated with the fraudulent entity based upon the identification of the fraudulent entity). Alternatively and/or additionally, implementation of at least some of the disclosed subject matter may lead to benefits including decreasing security resources needed to protect client devices and/or the content system from unauthorized access.

In some examples, at least some of the disclosed subject matter may be implemented on a client device, and in some examples, at least some of the disclosed subject matter may be implemented on a server (e.g., hosting a service accessible via a network, such as the Internet).

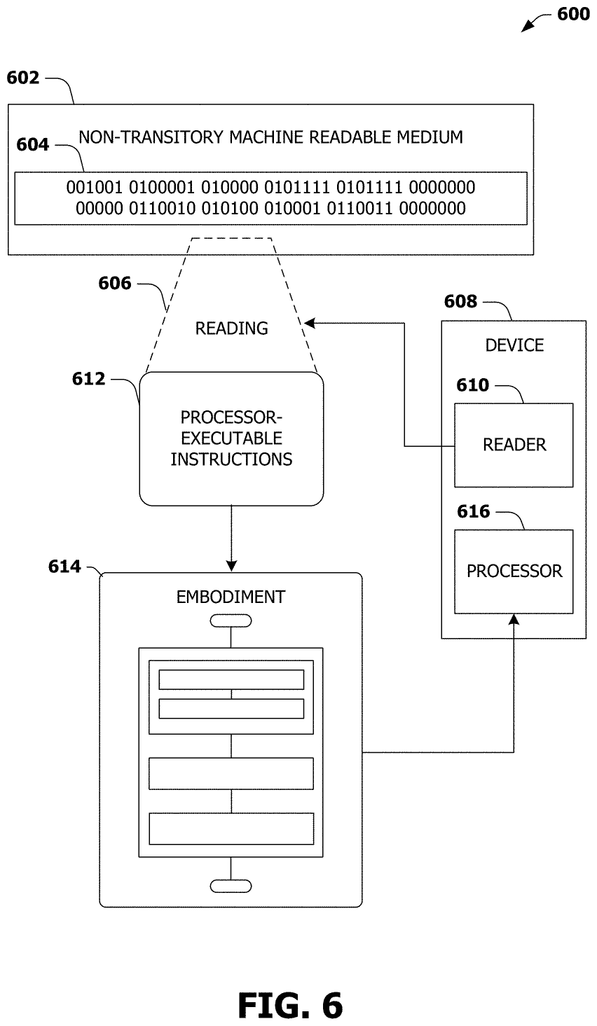

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein (e.g., embodiment 614). The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disc (CD), digital versatile disc (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed, cause performance of operations, such as at least some of the example method 400 of FIG. 4A and/or at least some of the example method 450 of FIG. 4B, for example. In some embodiments, the processor-executable instructions 612 are configured to cause implementation of a system, such as at least some of the exemplary system 501 of FIGS. 5A-5E, for example.

3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer and/or machine readable media, which if executed will cause the operations to be performed. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
determining first event information associated with a plurality of events within a period of time, wherein the plurality of events is associated with a plurality of entities;
determining, based upon the first event information, a plurality of sets of event metrics associated with the plurality of entities, wherein:
a first set of event metrics of the plurality of sets of event metrics is associated with a first entity of the plurality of entities; and
a second set of event metrics of the plurality of sets of event metrics is associated with a second entity of the plurality of entities;
determining, based upon the plurality of sets of event metrics, a first plurality of combined metrics, wherein determining the first plurality of combined metrics comprises:
determining a first combined metric of the first plurality of combined metrics based upon at least two event metrics of the first set of event metrics associated with the first entity; and
determining a second combined metric of the first plurality of combined metrics based upon at least two event metrics of the second set of event metrics associated with the second entity;
determining, based upon the first plurality of combined metrics, a threshold metric associated with anomalous behavior; and
determining that one or more first entities of the plurality of entities are fraudulent based upon the threshold metric and one or more combined metrics, of the first plurality of combined metrics, associated with the one or more first entities.

2. The method of claim 1, wherein a third entity of the one or more first entities is associated with a first internet resource, the method comprising:
receiving a first request associated with a first client device, wherein the first request corresponds to a request for content to be presented via the first internet resource; and
not transmitting a content item, associated with the first request, to the first client device based upon determining that the one or more first entities comprising the third entity are fraudulent.

3. The method of claim 1, wherein a third entity of the one or more first entities is associated with a first internet resource, the method comprising:
in response to determining that the one or more first entities are fraudulent, flagging the one or more first entities as fraudulent for a second period of time;
receiving, during the second period of time, a first request associated with a first client device, wherein the first request corresponds to a request for content to be presented via the first internet resource; and
not transmitting a content item, associated with the first request, to the first client device based upon a determination that the third entity is flagged as fraudulent.

4. The method of claim 1, wherein:
the first entity is associated with one or more first internet resources;
the first set of event metrics comprises at least one of:
a first measure of content item presentations via the one or more first internet resources during the period of time;
a first measure of bid requests associated with the one or more first internet resources during the period of time;
a first measure of device identifiers of devices associated with content item presentations via the one or more first internet resources during the period of time;
a first measure of user agents of bid requests associated with the one or more first internet resources during the period of time;
a first measure of network identifiers of networks from which bid requests associated with the one or more first internet resources are received during the period of time; or
a first measure of content item selections via the one or more first internet resources during the period of time;
the second entity is associated with one or more second internet resources; and
the second set of event metrics comprises at least one of:
a second measure of content item presentations via the one or more second internet resources during the period of time;
a second measure of bid requests associated with the one or more second internet resources during the period of time;
a second measure of device identifiers of devices associated with content item presentations via the one or more second internet resources during the period of time;
a second measure of user agents of bid requests associated with the one or more second internet resources during the period of time;
a second measure of network identifiers of networks from which bid requests associated with the one or more second internet resources are received during the period of time; or
a second measure of content item selections via the one or more second internet resources during the period of time.

5. The method of claim 4, wherein:
the at least two event metrics of the first set of event metrics comprises the first measure of user agents and the first measure of network identifiers; and
the at least two event metrics of the second set of event metrics comprises the second measure of user agents and the second measure of network identifiers.

6. The method of claim 4, wherein:
the at least two event metrics of the first set of event metrics comprises the first measure of device identifiers and the first measure of content item presentations; and
the at least two event metrics of the second set of event metrics comprises the second measure of device identifiers and the second measure of content item presentations.

7. The method of claim 1, wherein:
the first entity is associated with a first video streaming application; and
the second entity is associated with a second video streaming application.

8. The method of claim 7, wherein:
the at least two event metrics of the first set of event metrics comprises:
a first measure of video starts via the first video streaming application during the period of time; and
a first measure of video completions via the first video streaming application during the period of time;
the at least two event metrics of the second set of event metrics comprises:
a second measure of video starts via the second video streaming application during the period of time; and
a second measure of video completions via the second video streaming application during the period of time.

9. The method of claim 1, wherein:
determining that the one or more first entities are fraudulent is based upon a determination that the one or more combined metrics associated with the one or more first entities meet the threshold metric.

10. The method of claim 1, comprising:
determining a first value of a first percentile of the first plurality of combined metrics; and
determining a second value of a second percentile of the first plurality of combined metrics, wherein determining the threshold metric is based upon the first value and the second value.

11. A computing device comprising:
a processor; and
memory comprising processor-executable instructions that when executed by the processor cause performance of operations, the operations comprising:
determining first event information associated with a plurality of events within a period of time, wherein the plurality of events is associated with a first entity;
determining, based upon the first event information, a set of event metrics associated with the first entity;
determining, based upon at least two metrics of the set of event metrics, a first combined metric; and
determining, based upon the first combined metric and a threshold metric associated with anomalous behavior, whether the first entity is fraudulent.

12. The computing device of claim 11, wherein:
determining whether the first entity is fraudulent comprises determining that the first entity is fraudulent based upon the first combined metric meeting the threshold metric.

13. The computing device of claim 12, wherein the first entity is associated with a first internet resource, the operations comprising:
receiving a first request associated with a first client device, wherein the first request corresponds to a request for content to be presented via the first internet resource; and
not transmitting a content item, associated with the first request, to the first client device based upon determining that the first entity is fraudulent.

14. The computing device of claim 12, wherein the first entity is associated with a first internet resource, the operations comprising:
in response to determining that the first entity is fraudulent, flagging the first entity as fraudulent for a second period of time;
receiving, during the second period of time, a first request associated with a first client device, wherein the first request corresponds to a request for content to be presented via the first internet resource; and
not transmitting a content item, associated with the first request, to the first client device based upon a determination that the first entity is flagged as fraudulent.

15. The computing device of claim 11, wherein:
the first entity is associated with one or more first internet resources; and
the set of event metrics comprises at least two of:
a first measure of content item presentations via the one or more first internet resources during the period of time;
a first measure of bid requests associated with the one or more first internet resources during the period of time;
a first measure of device identifiers of devices associated with content item presentations via the one or more first internet resources during the period of time;
a first measure of user agents of bid requests associated with the one or more first internet resources during the period of time;
a first measure of network identifiers of networks from which bid requests associated with the one or more first internet resources are received during the period of time; or
a first measure of content item selections via the one or more first internet resources during the period of time.

16. The computing device of claim 15, wherein:
the at least two metrics of the set of event metrics comprises the first measure of user agents and the first measure of network identifiers.

17. The computing device of claim 15, wherein:
the at least two metrics of the set of event metrics comprises the first measure of device identifiers and the first measure of content item presentations.

18. The computing device of claim 11, wherein:
the first entity is associated with a first video streaming application.

19. A non-transitory machine readable medium having stored thereon processor-executable instructions that when executed cause performance of operations, the operations comprising:
determining first event information associated with a plurality of events within a period of time, wherein the plurality of events is associated with a plurality of entities;
determining, based upon the first event information, a plurality of sets of event metrics associated with the plurality of entities, wherein:
a first set of event metrics of the plurality of sets of event metrics is associated with a first entity of the plurality of entities; and
a second set of event metrics of the plurality of sets of event metrics is associated with a second entity of the plurality of entities;
determining, based upon the plurality of sets of event metrics, a first plurality of combined metrics, wherein determining the first plurality of combined metrics comprises:
determining a first combined metric of the first plurality of combined metrics based upon at least two event metrics of the first set of event metrics associated with the first entity; and
determining a second combined metric of the first plurality of combined metrics based upon at least two event metrics of the second set of event metrics associated with the second entity;
determining, based upon the first plurality of combined metrics, a threshold metric associated with anomalous behavior; and
determining that one or more first entities of the plurality of entities are fraudulent based upon the threshold metric and one or more combined metrics, of the first plurality of combined metrics, associated with the one or more first entities.

20. The non-transitory machine readable medium of claim 19, wherein a third entity of the one or more first entities is associated with a first internet resource, the operations comprising:
receiving a first request associated with a first client device, wherein the first request corresponds to a request for content to be presented via the first internet resource; and
not transmitting a content item, associated with the first request, to the first client device based upon determining that the one or more first entities comprising the third entity are fraudulent.
